(19) United States
(12) Patent Application Publication
(10) Pub. No.: US 2017/0212670 A1
(43) Pub. Date: Jul. 27, 2017

(54) DISPLAY CONTROL DEVICE, DISPLAY CONTROL METHOD, AND STORAGE MEDIUM

(71) Applicant: Sharp Kabushiki Kaisha, Osaka (JP)

(72) Inventor: Hiroyuki SHIMIZU, Sakai City (JP)

(73) Assignee: Sharp Kabushiki Kaisha, Osaka (JP)

(21) Appl. No.: 15/328,621

(22) PCT Filed: Jul. 14, 2015
(86) PCT No.: PCT/JP2015/070163

§ 371 Date: Jan. 24, 2017

(30) Foreign Application Priority Data
Jul. 31, 2014 (JP) 2014-157174

(51) Int. Cl. G06F 3/0488; G09G 5/38; G06F 3/0484; G06F 17/24; G06F 17/22

(52) U.S. Cl. CPC G06F 3/04883; G06F 17/24; G06F 17/2247; G06F 3/04845; G09G 5/38

(57) ABSTRACT

In order to (i) secure a display region of a screenshot and (i) display at least one of a title of a web page and a URL of the web page on which the screenshot is based, the smartphone (200, 300) includes a fifth display control section (71) configured to display the at least one of the title and the URL so that the at least one of the title and the URL overlaps with the screenshot.

### TECHNICAL FIELD

The present invention relates to a user interface for acquiring a screenshot.

### BACKGROUND ART

There has been conventionally known a technique for acquiring and displaying a screenshot. For example, Non-patent Literature 1 discloses a technique for (i) cutting out favorite web page, web video, image, or the like by using an S-pen and then (ii) storing the content thus cut out while pasting it into a board. There has also been known, as a conventional technique, a function, which allows a user to access a URL through a special viewer, of storing the web page together with the URL of the web page in a case where cut-out content is a web page.

### CITATION LIST

### Non-Patent Literature

### [Non-Patent Literature 1]

Scrapbook, [online], Functions of Smartphone GALAXY manufactured by Samsung Electronics, [Date of Search: Jul. 30, 2014], Internet URL: http://www.samsung.com/jp/consumer/flagship/SM-N900 DZKEDCM/Note3/tutorial/scrap_book.html

### SUMMARY OF INVENTION

### Technical Problem

However, such a conventional technique may cause a display region of a screenshot to be reduced. This is because, in a case where content of the screenshot, which is stored as described above, is a web page, a display screen is controlled to display the screenshot together with a URL of and a title of the web page, on which the screenshot is based.

The present invention has been accomplished in view of the above problem, and an object of the present invention is to provide a display control device and the like that (i) can display a screenshot without a display region of the screenshot being reduced because of a URL of and/or a title of the web page, on which the screenshot is based, and (ii) allows a user to easily change a browsing target from (a) the screenshot that is being browsed to (b) the web page on which the screenshot is based.

### Solution to Problem

In order to attain the above object, a display control device in accordance with an aspect of the present invention includes: a screenshot display section configured to control a display screen to display a first screenshot, the first screenshot being a screenshot of an image which was displayed on the display screen; and a web page display section configured to control, in a case where the first screenshot is a screenshot of a web page which was displayed on the display screen, the display screen to display at least one of a title of the web page and a URL of the web page so that the at least one of the title and the URL overlaps with the first screenshot.

Furthermore, in order to attain the above object, a method of controlling a display in accordance with an aspect of the present invention includes the steps of: (a) controlling a display screen to display a first screenshot, the first screenshot being a screenshot of an image which was displayed on the display screen; and (b) controlling, in a case where the first screenshot is a screenshot of a web page which was displayed on the display screen, the display screen to display at least one of a title of the web page and a URL of the web page so that the at least one of the title and the URL overlaps with the first screenshot.

### Advantageous Effects of Invention

According to an aspect of the present invention, a display control device and the like make it possible to (i) display a screenshot without a display region of the screenshot being reduced because of a URL of and/or a title of the web page, on which the screenshot is based, and (ii) allow a user to easily change a browsing target from (a) the screenshot that is being browsed to (b) the web page on which the screenshot is based.

### BRIEF DESCRIPTION OF DRAWINGS

FIG. 1 is a block diagram illustrating an example of a main configuration of a smartphone in accordance with Embodiment 1 of the present invention.

FIG. 2 is a view illustrating how a displayed screen undergoes a transition in response to a user's operation of acquiring and storing a screenshot by use of the smartphone. (a) of FIG. 2 illustrates an example of a screen displayed immediately before a user commences touching an end portion of a display section. (b) of FIG. 2 illustrates an example of a screen displayed immediately after the user commenced touching the end portion of the display section. (c) of FIG. 2 illustrates an example of a screen displayed in a case where the user moves the finger, having touched the end portion of the display section, along an upper side of the display section. (d) of FIG. 2 illustrates an example of a screen displayed in a case where the user moves the finger, having touched the end portion of the display section, along the upper side of the display section by a given distance or longer.

FIG. 3 is a view illustrating an example of a screenshot-acquiring-operation detecting region that is provided on the smartphone so as to detect a touch on an end portion of the display section.

FIG. 4 is a flowchart illustrating an example of a screenshot acquiring process.

FIG. 5 is a flowchart illustrating an example of a preview image displaying process for a screenshot.

FIG. 6 is a flowchart illustrating an example of a preview image moving process.

FIG. 7 is a flowchart illustrating an example of a process of storing or discarding an acquired screenshot.

FIG. 8 is a flowchart illustrating an example of how the processes illustrated in FIGS. 4 through 7 are consecutively carried out.

FIG. 9 is a view illustrating an example of a user's operation of storing or discarding an acquired screenshot. (a) of FIG. 9 is a view illustrating an example of a user's operation of storing a screenshot. (b) of FIG. 9 is a view illustrating an example of a user's operation of discarding a screenshot.

FIG. 10 is a view illustrating another example of a user's operation of discarding a screenshot.

FIG. 11 is a block diagram illustrating a main configuration of a smartphone in accordance with Embodiment 3 of the present invention.

FIG. 12 is a view illustrating an example of how to provide, in the smartphone illustrated in FIG. 11, a sensor for acquiring a touch on an end portion of a display section.

FIG. 13 is a block diagram illustrating a configuration of a computer by which each of the above smartphones can be realized.

FIG. 14 is a block diagram illustrating an example of a main configuration of a smartphone in accordance with Embodiment 4 of the present invention.

FIG. 15 is a view illustrating examples of two types of screenshots that the smartphone illustrated in FIG. 14 stores in response to a user's operation.

FIG. 16 is a view illustrating an example of data stored in a storage section of the smartphone illustrated in FIG. 14. (a) of FIG. 6 is a view illustrating an example of a new-type screenshot storage table. (b) of FIG. 6 is a view illustrating an example of a display condition managing table. (c) of FIG. 6 is a view illustrating an example of a display condition defining table.

FIG. 17 is a flowchart illustrating an example of a process that the smartphone illustrated in FIG. 14 carries out to switch between display and non-display of a GUI in response to a user's operation.

FIG. 18 is a view illustrating an example of a table in which the two types of screenshots illustrated in FIG. 15 are to be stored.

FIG. 19 is a view illustrating how a screen displayed in the smartphone illustrated in FIG. 14 undergoes a transition in response to a user's operation.

FIG. 20 is a block diagram illustrating a main configuration of a smartphone in accordance with Embodiment 5 of the present invention.

FIG. 21 is a view illustrating how a screen displayed in the smartphone illustrated in FIG. 20 undergoes a transition in response to a user's operation.

### DESCRIPTION OF EMBODIMENTS

### Embodiment 1

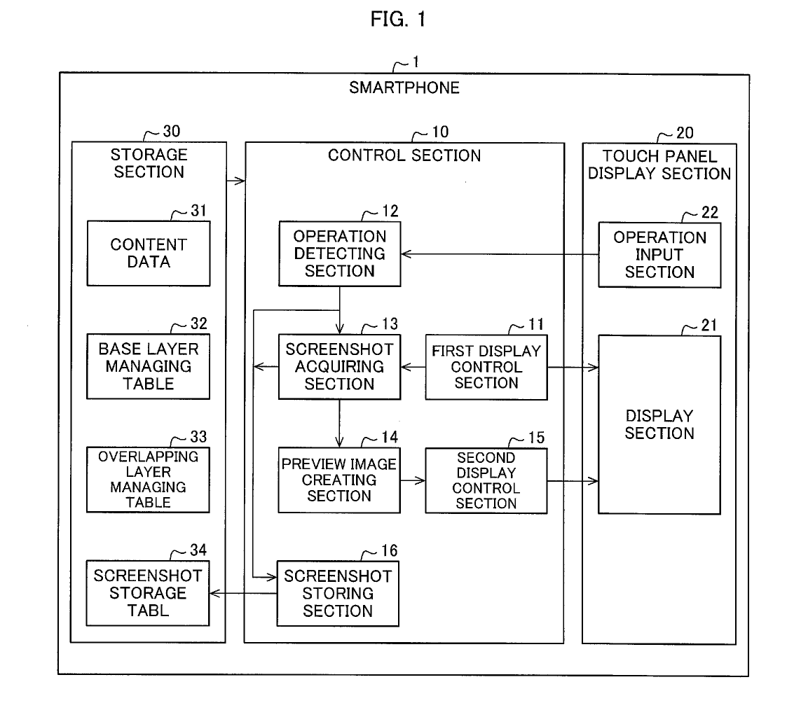

The following description will discuss in detail Embodiment 1 of the present invention with reference to FIGS. 1 through 9. Embodiment 1 will discuss an example in which the present invention is realized by a smartphone (display control device) 1. The smartphone 1 includes a touch panel display section 20. The touch panel display section 20 includes (i) a display section 21 (display screen) and (ii) an operation input section 22, which is provided so as to overlap with the display section 21. Note that the smartphone 1 does not necessarily include the operation input section 22, which is provided so as to overlap with the display section 21 (later described in detail), provided that the smartphone 1 can detect a touch on an end portion of the display section 21 which touch is intended to acquire a screenshot. That is, the smartphone 1 does not necessarily include the touch panel display section 20, provided that the smartphone 1 includes the display section 21 and a sensor for detecting a touch on an end portion of the display section 21. Note also that Embodiment 1 is not limited to be applied to a smartphone but is applicable to any display control device that includes a display screen and a detection section for detecting a touch on an end portion of the display screen.

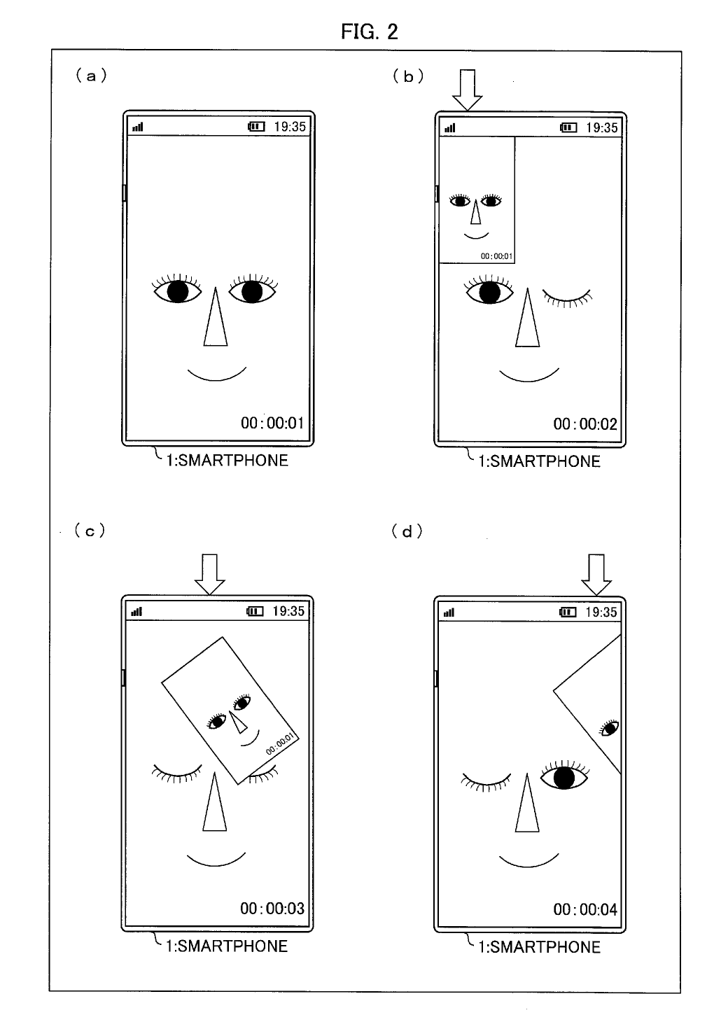

The following description will first discuss, with reference to FIG. 2, (i) a flow of an operation in which a user attempts to acquire, by use of the smartphone 1, a screenshot of content displayed on the display section 21 and (ii) how a screen, displayed on the display section 21, undergoes a transition in response to the operation. Note that (a) a commencement of a user's touch on an end portion of the display section 21 will be hereinafter referred to as “touch commencement” and (b) a user's take-off of such a touch from an upper side of the display section 21 will be hereinafter referred to as “touch completion.” Note also that (i) a position, at which a touch commencement has occurred, will be hereinafter referred to as a “touch commencement position” and (ii) a position, at which a user's touch existed immediately before the touch completion will be hereinafter referred to as a “touch completion position”.

[Outline of Operations Conducted from Acquiring of Screenshot to Storing/Discarding of an Acquired Screenshot]

FIG. 2 is a view illustrating how a screen, displayed on the display section 21, undergoes a transition in response to a user's operation of acquiring a screenshot by use of the smartphone 1. The outline of a user's operation of acquiring a screenshot by use of the smartphone 1 will be first discussed below. Specifically, in a case where the user touches an end portion (upper left end portion) of the display section 21, a screenshot is acquired, and then a preview image of the screenshot thus acquired is displayed (see (a) of FIG. 2). Thereafter, the screenshot is stored (see (d) of FIG. 2), when the user takes off a touch after having moved the touch, by a given distance or longer, from a touch commencement position along the upper side of the display section 21 while dragging the preview image. Note that, in a case where the user has dragged the preview image by smaller than a given amount, i.e., in a case where the user has moved the preview image, while dragging thereof, by shorter than a given distance, the screenshot is discarded. While the preview image is being drugged, the preview image (i) leans in accordance with a distance by which the touch has been moved from the touch commencement position and (ii) moves in accordance with a movement of the touch (see (c) of FIG. 2). Each of (a) through (d) of FIG. 2 will be discussed in detail below. Note that each downward arrow illustrated in (a) through (d) of FIG. 2 indicates a position at which the user is touching the touch panel display section 20 with a finger.

(a) of FIG. 2 illustrates an example of a screen displayed on the display section 21 at a time point when the user touches the upper left end portion of the touch panel display section 20. (a) of FIG. 2 illustrates the smartphone 1 playing back content at a time point when the user commences touching the upper left end portion of the touch panel display section 20. Note that a playback time of the content displayed on the display section 21 is indicated by “00:00:01”.

(b) of FIG. 2 illustrates an example of a screen displayed, on the display section 21, immediately after the user commenced touching the upper left end portion of the touch panel display section 20. As illustrated in (b) of FIG. 2, a reduced image of the content, which was displayed on the display section 21 at a time point when the user commenced touching the upper left end portion of the display section 21 (i.e. the content whose playback time was indicated by “00:00:01”), is displayed on the display section 21 as a preview image. In (b) of FIG. 2, content, which is being played back by the smartphone 1, is displayed behind the preview image, and a playback time of the content is indicated by “00:00:02.” That is, the display section 21 displays the reduced image of the content, displayed at a time point when the user commenced touching the upper left end portion of the touch panel display section 20, so that the reduced image overlaps with content that is being played back by the smartphone 1. The smartphone 1 thus displays a preview image so that the preview image overlaps with content that is being played back. Note that in (b) of FIG. 2, a finger of the user is on the upper left end portion of the touch panel display section 20.

(c) of FIG. 2 illustrates an example of a screen which is displayed on the display section 21, in a case where the user moves rightward a finger, which has been touched the upper left end portion of the touch panel display section 20, along the upper side of the touch panel display section 20. The preview image commences leaning, in a case where the user slightly traces the upper side of the touch panel display section 20 with the finger, which has touched the upper left end portion of the touch panel display section 20. In a case where the user further moves rightward the finger, which has touched the upper side of the touch panel display section 20, a display of the preview image, displayed on the display section 21, moves rightward in accordance with the movement of the finger. Note that a playback time of the content being displayed behind the preview image is indicated by “00:00:03”.

(d) of FIG. 2 illustrates an example of a screen, displayed on the display section 21 in a case where the user moves rightward, by a given distance or longer, the finger, which has touched the upper left end portion of the touch panel display section 20, along the upper side of the touch panel display section 20. In a case where the finger, which has touched the upper left end portion of the touch panel display section 20, is moved rightward by the given distance or longer while being in contact with the upper side of the touch panel display section 20, the preview image is flown off from the screen of the display section 21, and then a screenshot of the content, which was displayed on the display section 21 at a time point when the user commenced touching the upper left end portion of the touch panel display section 20, is stored. Note that content whose playback time is indicated by “00:00:04” is displayed behind the preview image. The smartphone 1 thus allows the user to (i) acquire a screenshot by simply tracing the upper side of the touch panel display section 20 with a finger and then (ii) store the screenshot thus acquired after checking the screenshot through the preview image.

An outline of a conventional method of acquiring a screenshot will be discussed below so that it can be compared with a method of acquiring, checking, and storing, or discarding a screenshot by use of the smartphone 1. The screenshot acquiring methods disclosed in Non-patent Literatures 1 through 3 can be broadly classified into two methods. Specifically, according to the techniques disclosed in Non-patent Literatures 1 and 2, in a case where a user conducts an operation of acquiring (storing) a screenshot, the screenshot is automatically stored without an image, based on which the user determines whether to store the screenshot, being displayed. It follows that the user cannot determine whether the screenshot should be stored or not before storing it. Thus, in a case where the user attempts to acquire a screenshot of moving content, particularly such as moving image, there is the possibility that the user accidentally stores an image different from an intended image, i.e., a useless image. There has also been conventionally known a technique of acquiring (storing) a screenshot by simultaneously pressing two or more buttons (e.g., “power button” and “home button”). According to such a technique, however, a screenshot is stored simultaneously with the pressing of the two or more buttons, and it is therefore not possible for the user to determine whether the screenshot should be stored or not before storing it. Meanwhile, according to the technique disclosed in Non-patent Literature 3, in a case where a user's operation of acquiring a screenshot is accepted, a screen, via which the user determines whether to store the screenshot thus acquired by the user's operation, is displayed. However, the technique disclosed in Non-patent Literature 3 requires the user to press a “storage button” on a main screen in order to store or discard an acquired screenshot. That is, the technique disclosed in Non-patent Literature 3 requires the user to conduct a plurality of discontinuous operations to acquire, determine, and then store or discard a screenshot, and thus lacks immediacy.

In contrast, the smartphone 1 can carry out the following processes (1) through (5). (1) Upon detection of a touch on an end portion of the display section 21, the smartphone 1 acquires a screenshot of content (i.e., a screen of the display section 21) that was displayed on the display section 21 at a time point when the touch was commenced. Then, the smartphone 1 displays, as a preview image of the screenshot, a reduced image of the content, which was displayed on the display section 21 at a time point when the touch was commenced. (2) Upon detection of a user's operation of tracing a touch (finger) along the upper side of the display section 21, i.e., upon detection of a user's operation of drugging the preview image, the smartphone 1 controls the preview image to move in accordance with a movement of the finger. (3) According to the smartphone 1, an application screen which had been operated behind the preview image before the user touched the end portion of the display section 21 continues to operate behind the preview image even after the user touched the end portion of the display section 21. For example, in a case where content, which was played back on the display section 21 by the smartphone 1 at a time point when the user commenced touching the end portion of the display section 21, was a moving image, the smartphone 1 continues to play back the moving image behind the preview image. That is, the smartphone 1 (i) continues to play back the content, which was played back on the display section 21 at a time point when the user commenced touching the end portion of the display section 21 and (ii) displays the preview image so that the preview image overlaps with the content being played back. (4) Upon detection of a user's operation of taking off a finger from the upper side of the display section 21 after the finger traced the upper side of the display section 21 by a given distance or longer, the smartphone 1 (i) displays the preview image so that the preview image is flown off from the screen and then (ii) stores the screenshot. That is, the smartphone 1 (i) displays the preview image so that the preview image is flown off from the screen in response to the user's operation and then (ii) stores the screenshot, which was acquired at a time point when detection of the touch on the end portion of the display section 21 was commenced. (5) Upon detection of the finger having been taken off from the upper side of the display section 21 before the finger traces, by the given distance, the upper side of the display section 21, the smartphone 1 (i) controls the preview image to fade out and then (ii) cancels storing of the screenshot. The smartphone 1 also cancels storing of the screenshot, in a case where it detects (a) the finger having traced, by the given distance, the upper side of the display section 21, (b) the finger having turned back, by a distance shorter than the given distance, from the end portion of the display section 21, and then (c) the finger having been taken off from the upper side of the display section 21.

By carrying out the above processes (1) through (5), the smartphone 1 brings about the following effects that cannot be brought about by the conventional screenshot acquiring methods disclosed in Non-patent Literatures 1 through 3. That is, the process (1) allows the user to determine a preview image of a screenshot before storing the screenshot. The processes (2) and (3) allow the user to compare the preview image with an application that is in execution (content that is being played back). As such, the user can determine whether or not the screenshot is a screenshot of an intended image (in the case of moving content such as a moving image, the user can determine whether or not the screenshot was acquired at an optimal timing). Since the user can acquire a screenshot through an operation of touching the end portion of the display section 21, the display section 21 will never be hidden by a hand of the user who attempts to conduct an operation of acquiring a screenshot. Furthermore, the display section 21 will never be hidden by a hand of the user who attempts to conduct an operation of displaying the preview image of the screenshot thus acquired. It follows that the preview image and an application which is being executed can be checked without being hidden by the hand of the user.

Furthermore, according to the smartphone 1, (i) the display section 21 has substantially no rim (part of a housing surrounding a periphery of the display section 21 which is parallel to a display surface of the display section 21) and (ii) a display part of the housing (part surrounding the periphery of the display surface of the display section 21) is subjected to C chamfering (chamfer plane). This allows the user to smoothly trace, with his/her finger, an upper end portion of and the upper side of the display section 21.

In a case where the user does not want to store a screenshot, the user can easily cancel storing of the screenshot by conducting the process (5) of the smartphone 1, thereby avoiding storing of a useless screenshot. Furthermore, motions of (i) placing a finger on an end portion of the display section 21, (ii) tracing the rim (upper side) of the display section 21 with the finger, and then (iii) taking off the finger from the display section 21 are a series of motions that the user can seamlessly make. It follows that the user can (i) acquire a screenshot, (ii) check a preview image of the screenshot, and (iii) store/discard the screenshot, through a single seamless procedure. The following description will discuss an outline of a configuration of the smartphone 1, as has been described, which can improve operability of the user who attempts to acquire, determine, and store/discard a screenshot.

Upon detection of a touch on an end portion of the display section 21 (more specifically, a touch on an end portion of the touch panel display section 20), the smartphone 1 acquires a screenshot of content that was displayed on the display section 21 at a time point when the touch was commenced. That is, the smartphone 1 includes a first display control section 11 configured to control the display screen 21 to display content, an operation detecting section 12 (detection section) configured to detect a touch on an end portion of the display screen 21, and a screenshot acquiring section 13 (acquisition section) configured to acquire, in a case where the operation detecting section 12 detects a touch on the end portion, a screenshot of content which the first display control section 11 controls the display screen 21 to display. As such, the smartphone 1 allows the user to acquire a screenshot by simply touching an end portion of the display section 21 (more specifically, by simply touching an end portion of the touch panel display section 20). That is, the smartphone 1 can simplify an operation of acquiring a screenshot, as compared with the conventional techniques that require a motion such as tracing a touch panel with a finger, so as to acquire a screenshot. According to such conventional techniques that require a motion such as tracing, with a finger, a display screen having a touch panel so as to acquire a screenshot, the user involved a risk of accidentally touching, while making a motion of tracing the display screen with a finger, a software button and/or the like that is displayed on the display screen. In contrast, since the smartphone 1 allows the user to acquire a screenshot by simply touching an end portion of the display section 21, it can reduce the risk caused by such an erroneous operation. Since the smartphone 1 merely requires the user to touch an end portion of the display section 21 so as to acquire a screenshot, the display section 21 will never be hidden by a hand with which the user attempts to touch the display section 21. It follows that the user can acquire a screenshot while determining content displayed on the display section 21. If the user needs to touch the vicinity of the center of the touch panel display section 20 so as to acquire a screenshot, the user involves a risk of accidentally touching a software button or the like that is displayed in the vicinity of the center of the touch panel display section 20. In contrast, since the smartphone 1 allows the user to acquire a screenshot by simply touching an end portion of the display section 21, it is possible for the user to reduce the risk of conducting such an erroneous operation.

The smartphone 1 further includes (i) a preview image creating section 14 (creating section) configured to create a preview image of the screenshot acquired by the screenshot acquiring section 13, and (ii) a second display control section 15 configured to control the display screen 21 to display the preview image thus created by the preview image creating section 14. That is, the smartphone 1 controls the display section 21 to display a preview image of the screenshot. This allows the user to determine the screenshot before storing it. Note that the smartphone 1 that allows the user to acquire a screenshot through a single touch does not necessarily include the preview image creating section 14 and the second display control section 15.

The operation detecting section 12 detects (i) the touch moving along at least one side of the display section 21 and (ii) the touch being away from the at least one side, the at least one side including the end portion. The smartphone 1 further includes a screenshot storing section 16 (storing section) configured to determine whether to store or discard the screenshot, in accordance with whether or not a distance from a touch commencement position to a touch completion position is equal to a given distance or longer, the touch commencement position being a position at which the operation detecting section 12 commenced detection of the touch, the touch completion position being a position at which the touch has been away from the at least one side. That is, the smartphone 1 determines whether to store or discard the screenshot, in accordance with whether or not the distance from the touch commencement position to the touch completion position is equal to the given distance or longer. This allows the user to acquire and store/discard a screenshot through a continuous motion.

The second display control section 15 controls the display screen 21 to display the preview image so that the preview image overlaps with the content which the first display control section 11 controls the display screen 12 to display. That is, the smartphone 1 displays the preview image so that the preview image overlaps with content displayed on the display section 21. This allows the user to compare the preview image with the content displayed on the display section 21, and ultimately allowing the user to correctly determine whether to store or discard the screenshot. Particularly in a case where the content displayed on the display section 21 is moving content such as a moving image, the user can compare, while watching the content that is being played back on the display section 21, the preview image with the content. This allows the user to easily determine whether or not a screenshot of the content, which is being played back, could be acquired at an optimal timing.

The second display control section 15 controls the display screen 12 to move a display position of the preview image in accordance with the movement detected by the operation detecting section 12. That is, the smartphone 1 moves the display position of the preview image in accordance with a movement of the touch along the side of the display section 21. This allows the user to correctly determine whether to store or discard the screenshot while moving the preview image and checking content displayed on the display section 21.

[Device Configuration]

A configuration of a smartphone 1 will be discussed below with reference to FIG. 1. FIG. 1 is a block diagram illustrating an example of a main configuration of the smartphone 1. As illustrated in FIG. 1, the smartphone 1 includes a control section 10, a touch panel display section 20, and a storage section 30. Note that, for simplification, components that are not directly relevant to Embodiment 1 (e.g., configuration that allows the smartphone 1 to communicate with external devices) are omitted in each of the following descriptions and the block diagram. Note, however, that the smartphone 1 can include such components in accordance with actual conditions of implementations.

[Configuration of Control Section]

The control section 10 comprehensively controls functions of the smartphone 1. The control section 10 includes a first display control section 11, an operation detecting section 12, a screenshot acquiring section 13, a preview image creating section 14, a second display control section 15, and a screenshot storing section 16.

The first display control section 11 controls the display section 21 to display content. Specifically, the first display control section 11 controls the display section 21 to display content stored in content data 31 (later described). The operation detecting section 12 accepts an input signal corresponding to an input operation that has been entered via the operation input section 22. Then, the operation detecting section 12 identifies an operation conducted by the user, based on (i) the input signal and (ii) an image displayed on the display section 21. The operation detecting section 12 then controls sections of the control section 10 to carry out respective processes corresponding to the operation thus identified. Specifically, the operation detecting section 12 detects a touch on an end portion (such as upper left end portion) of the display section 21. The operation detecting section 12 can also detect (i) a movement of a touch made along at least one side of the display section 21 (e.g., an upper side of the display section 21) which at least one side includes the end portion and (ii) the touch being away from the at least one side of the operation detecting section 12.

In a case where the operation detecting section 12 detects a touch on an end portion of the display section 21, the screenshot acquiring section 13 acquires a screenshot of content which the first display control section 11 controls the display section 21 to display. Specifically, the screenshot acquiring section 13 carries out the following process, in a case where the operation detecting section 12 informs the screenshot acquiring section 13 that it has detected a touch on an end portion of the display section 21 (i.e., a touch on an end portion of the touch panel display section 20). That is, the screenshot acquiring section 13 acquires, as a screenshot from the first display control section 11, an image which was displayed on the display section 21 (screen of the display section 21) at a timing when the operation detecting section 12 detected a commencement of the touch on the end portion of the display section 21.

The preview image creating section 14 creates a preview image of the screenshot acquired by the screenshot acquiring section 13. Specifically, the preview image creating section 14 acquires the screenshot from the screenshot acquiring section 13, and then creates a reduced image of the screenshot thus acquired. Note that how the preview image creating section 14 creates a preview image is not limited to as such. Alternatively, the preview image creating section 14 can create a preview image by, for example, (i) acquiring, from the first display control section 11, an image that was displayed on the display section 21 (screen of the display section 21) at a time point when the operation detecting section 12 detected a commencement of the touch on an end portion of the display section 21 and then (ii) creating, as a preview image, a reduced image of the image thus acquired.

The second display control section 15 controls the display section 21 to display the preview image created by the preview image creating section 14. Note that according to the smartphone 1, the second display control section 15 can control the display section 21 to display the preview image, by overlapping the content, which the first display control section 11 controls the display section 21 to display, with a preview image created by the preview image creating section 14 (later described). Furthermore, the second display control section 15 can control the display section 21 to move the preview image toward a position in accordance with an input operation which causes the preview image to move. The screenshot storing section 16 determines whether to store or discard the screenshot, in accordance with whether or not a distance from (i) a touch commencement position, at which the touch detected by the operation detecting section 12 was commenced, to (ii) a touch completion position, at which the touch was away from the side of the display section 21, is equal to a given distance or longer. Specifically, in a case where the distance between (i) the touch commencement position to (ii) the touch end position is equal to the given distance or longer, the screenshot storing section 16 stores the screenshot in a screenshot storage table 34. In contrast, in a case where the distance between (i) the touch commencement position and (ii) the touch completion position is shorter than the given distance, the screenshot storing section 16 discards the screenshot.

[Configuration of Touch Panel Display Section]

The touch panel display section 20 includes the display section 21 and the operation input section 22 which is provided so as to overlap with the display section 21. The display section 21 is a display device for displaying an image which the control section 10 controls the display section 21 to display. The operation input section 22 is an input device via which the smartphone 1 accepts an input operation conducted by the user and then supplies the input operation to the control section 10. The following description will discuss an example in which the display section 21 and the operation input section 22 are configured such that a display surface of the display section 21 serves as an input surface of the operation input section 22. That is, the following description will discuss an example in which the smartphone 1 includes a touch panel. Note that Embodiment 1 is not limited to as such, provided that (i) the display section 21 has a function of displaying an image and (ii) the operation input section 22 has a function of accepting an input operation. The operation input section 22 is not particularly limited, provided that it is capable of entering a user's touch on an end portion of the display section 21, and is therefore not necessarily a touch panel that is provided so as to overlap with the display section 21. Alternatively, the display section 21 and the operation input section 22 can be achieved by an external device that is externally connected to the smartphone 1.

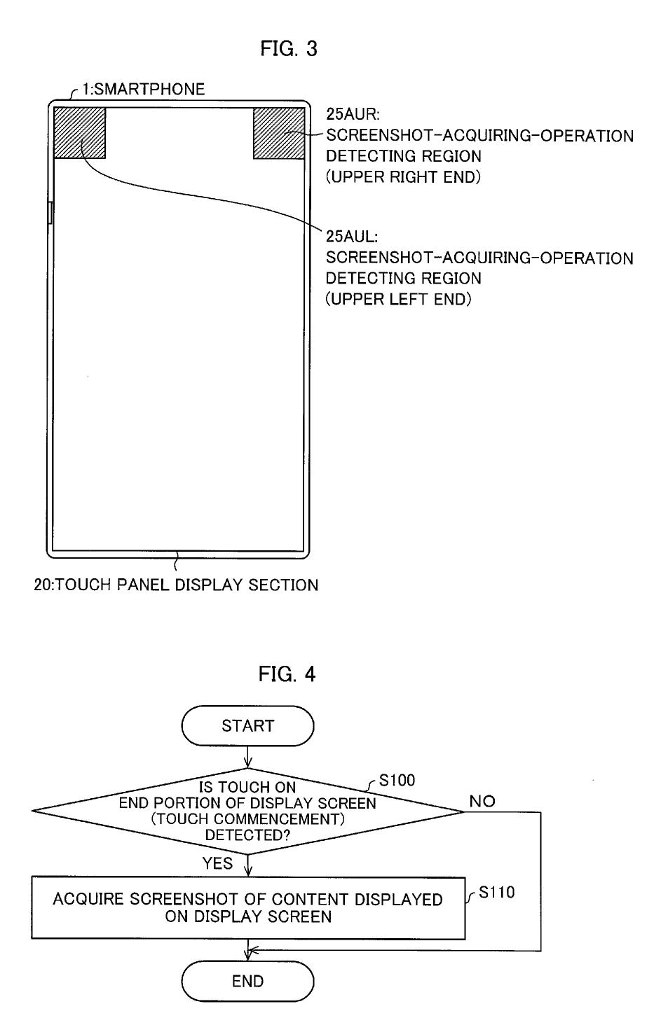

Typical and conventional smartphones are each configured such that a housing surrounds a periphery of a touch panel display section. It follows that, when the touch panel display sections of such typical and conventional smartphones are each viewed from the front side, a rim having a certain width is secured so as to surround the periphery of the touch panel display section. That is, the typical and conventional smartphones each configured so that a structure in which a rim of a housing, which rim has a certain width, surrounds a periphery of a touch panel display section. In contrast, (i) the smartphone 1 has substantially no rim that surrounds the periphery of the touch panel display section 20 and (ii) the periphery of the touch panel display section 20 is subjected to C chamfering. FIG. 3 is a view illustrating an example in which (i) a screenshot-acquiring-operation detecting region (right side) 25AUR and (ii) a screenshot-acquiring-operation detecting region (left side) 25AUL are secured so as to detect a touch on an end portion of the display section 21 of the smartphone 1. Note that, in a case where it is unnecessary to particularly distinguish between the screenshot-acquiring-operation detecting region (right side) 25AUR and the screenshot-acquiring-operation detecting region (left side) 25AUL, the regions will be hereinafter merely referred to as a screenshot-acquiring-operation detecting region 25A.

According to the smartphone 1, an application for acquiring a screenshot (hereinafter referred to as a “screenshot application”) and a general application(s) are operated in a multitasking environment. That is, a layer intended for the screenshot application is to be superimposed on another layer intended for a general application (i.e., an application different from the “screenshot application”, such as an application for playing back content). In a case where the smartphone 1 detects a touch on region (shaded region illustrated in FIG. 3) away, by a certain distance, from an end portion of the touch panel display section 20, i.e., in a case where the smartphone 1 detects a touch on the screenshot-acquiring-operation detecting region 25A, the smartphone 1 creates a reduced image of content which is being displayed on the display section 21. Note that, in a case where the smartphone 1 detects a touch on a region outside the screenshot-acquiring-operation detecting region 25A, the smartphone 1 operates in an application environment which is being displayed on the display section 21. As such, the smartphone 1 can distinguish between (i) a touch on the screenshot-acquiring-operation detecting region 25A and (ii) a touch operation to the general application.

[Data to be Stored in Storage Section]

The storage section 30 is a storage device which is configured to store various data to be used by the smartphone 1. The storage section 30 includes content data 31, a base layer managing table 32, an overlapping layer managing table 33, and a screenshot storage table 34. The content data 31 stores content to be displayed in a base layer (later described). The content data 31 can be alternatively realized by, for example, a video RAM (VRAM). Embodiment 1 describes an example in which the smartphone 1 displays content stored in the content data 31 of the storage section 30. Embodiment 1 does not, however, particularly limit as to from where content to be displayed on the display section 21 is acquired. Alternatively, the content to be displayed on the display section 21 can be acquired, for example, via a communication network or from a recording medium, such as a memory card, in which content is stored and which is connected to the smartphone 1. The base layer managing table 32 stores therein information that the first display control section 11 uses to cause content to be displayed. The overlapping layer managing table 33 stores therein information that the second display control section 15 uses to cause a preview image to be displayed. Note that a layer intended for the first display control section 11 to display content is different from a layer intended for the second display control section 15 to display a preview image. A layer intended for the first display control section 11 to carry out a process will be hereinafter referred to as a base layer, and a layer intended for the second display control section 15 to carry out a process will be hereinafter referred to as an overlapping layer. The screenshot storage table 34 stores screenshots acquired by the screenshot acquiring section 13. That is, the screenshot storing section 16 stores, in the screenshot storage table 34, screenshots acquired by the screenshot acquiring section 13.

[Outline of Processes to be Carried Out by Smartphone]

Processes to be carried out by the smartphone 1 can be broadly classified into (i) a screenshot acquiring process, (ii) a preview image displaying process, (iii) a preview image moving process, and (iv) a screenshot storing/discarding process. The screenshot acquiring process is for acquiring a screenshot. The preview image displaying process is for displaying a preview image of the screenshot acquired through the screenshot acquiring process. The preview image moving process is for moving a display position of the preview image. The screenshot storing/discarding process is for storing or discarding the screenshot acquired through the screenshot acquiring process. Each of the processes will be specifically discussed below.

[Screenshot Acquiring Process]

FIG. 4 is a flowchart illustrating an example of the screenshot acquiring process. In a case where the smartphone 1 detects a touch (touch commencement) on an end portion of the display section 21 (YES in S100), the smartphone 1 acquires a screenshot of content displayed on the display section 21 (S110). While no touch is being detected on the end portion of the display section 21 (NO in S100), the smartphone 1 does not carry out the screenshot acquiring process (i.e., the smartphone 1 does not acquire a screenshot). Thus, the screenshot acquiring process of the smartphone 1 includes (i) a first display control step of displaying content on the display section 21, (ii) a detection step (S100) of detecting a touch on an end portion of the display section 21, and (iii) an acquisition step (S110) of acquiring, in a case where a touch on the end portion is detected in the detection step, a screenshot of the content, which is being displayed on the display section 21 in the first display control step.

[Preview Image Displaying Process]

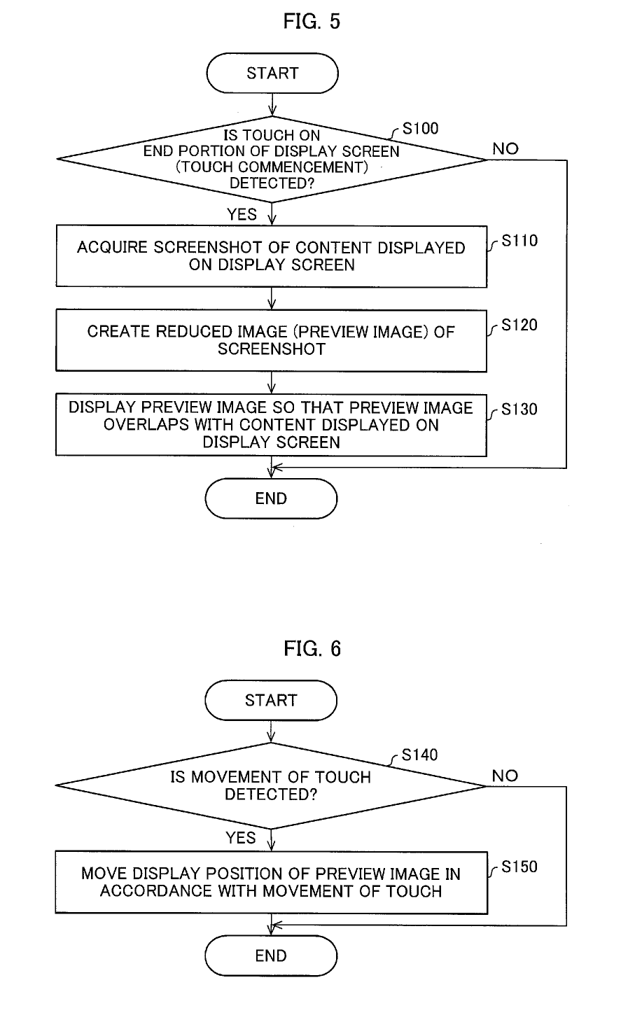

FIG. 5 is a flowchart illustrating an example of how the smartphone 1 processes, in a case where the smartphone 1 carries out the preview image displaying process in which a preview image of a screenshot is to be displayed after the screenshot is acquired. Note that S100 and S110 illustrated in FIG. 5 are identical to S100 and S110 illustrated in FIG. 4, respectively, and thus descriptions of S100 and S110 are omitted.

After carrying out the screenshot acquiring process (S100 and S110), the smartphone 1 creates a reduced image (preview image) of the screenshot (S120). Subsequently, the smartphone 1 displays the preview image so that the preview image overlaps with the content displayed on the display section 21 (S130). That is, a method of controlling the smartphone 1 includes a creating step (S120) of creating a preview image of the screenshot acquired in the acquisition step (S110) and (ii) a second display control step (S130) of displaying, on the display screen, the preview image thus created in the creating step.

Note that, in the second display control step of the method of controlling the smartphone 1, the preview image is displayed so as to overlap with the content, which is displayed on the display section 21 in the first display control step. Note, however, that it is not fundamental to the smartphone 1 that the preview image is displayed so as to overlap with the content. Alternatively, for example, the preview image can be displayed on the entire surface of the display section 21 so that the content is not displayed behind the preview image. Furthermore, the smartphone 1 can carry out, independently of the preview image displaying process, processes (e.g., the screenshot acquiring process and the screenshot storing/discarding process) other than the preview image displaying process. That is, the smartphone 1 can carry out at least one of the screenshot acquiring process and the screenshot storing/discarding process, instead of carrying out the preview image displaying process.

[Preview Image Moving Process]

FIG. 6 is a flowchart illustrating an example of the preview image moving process. In a case where the smartphone 1 detects a movement of a touch after carrying out the preview image displaying process (YES in S140), i.e., in a case where the smartphone 1 detects the touch, on the display section 21, having been moved along the upper side of the display section 21, the smartphone 1 carries out the following process. That is, the smartphone 1 moves, in accordance with a movement of the touch, a display position of the preview image (S150). In a case where the smartphone 1 does not detect the movement of the touch (NO in S140), the smartphone 1 will never carry out the preview image moving process (i.e., the smartphone 1 will never move the preview image). That is, the preview image moving process carried out by the smartphone 1 includes the step of moving the display position of the preview image in accordance with a movement of the touch made along at least one side, including the end portion, of the display section 21. Note that the smartphone 1 can carry out, independently of the preview image moving process, processes (e.g., the screenshot acquiring process, the preview image displaying process, and the screenshot storing/discarding process) other than the preview image moving process. That is, the smartphone 1 can carry out at least one of the screenshot acquiring process, the preview image displaying process, and the screenshot storing/discarding process, instead of carrying out the preview image moving process.

[Screenshot Storing/Discarding Process]

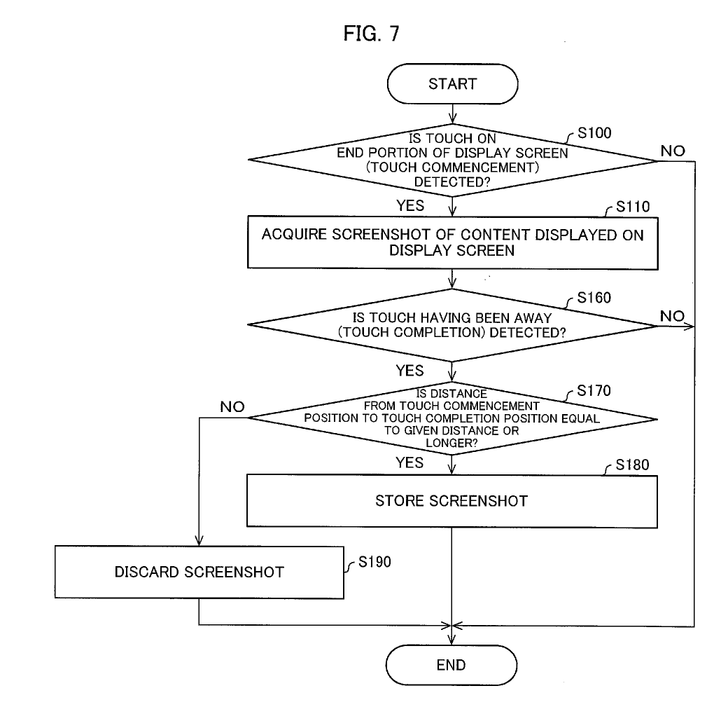

FIG. 7 is a flowchart illustrating an example of how the smartphone 1 carries out the process in which the screenshot is stored or discarded (the screenshot storing/discarding process) after the screenshot is acquired. Note that S100 and S110 illustrated in FIG. 7 are identical to S100 and S110 illustrated in FIG. 4, respectively, and thus descriptions of S100 and S110 are omitted. After carrying out the screenshot acquiring process (S100 and S110), the smartphone 1 can further carry out the screenshot storing/discarding process as below. In a case where the smartphone 1 detects the touch having been away (i.e., detects a touch completion) (YES in S160), i.e., in a case where the smartphone 1 detects the touch having been away from the upper side of the display section 21, the smartphone 1 carries out the following process. That is, the smartphone 1 determines whether or not a distance from the touch commencement position to the touch completion position is equal to a given distance or longer (S170). Specifically, the smartphone 1 acquires a distance from (i) a position (touch commencement position) at which a touch, on an end portion of the display section 21, was located when the operation detecting section 12 commenced detection of the touch to (ii) a position (touch completion position) at which the touch was located just before the operation detecting section 12 detected the touch having been away from the upper side of the display section 21. In a case where the distance from the touch commencement position to the touch completion position is equal to the given distance or longer (YES in S170), the smartphone 1 stores the screenshot (S180). In contrast, in a case where the distance from the touch commencement position to the touch completion position is shorter than the given distance (NO in S170), the smartphone 1 discards the screenshot (S190). That is, the screenshot storing/discarding process includes a storing step (S170) of determining whether to store or discard the screenshot, in accordance with whether or not the distance from the touch commencement position to the touch completion position is equal to the given distance or longer. Note that the smartphone 1 can carry out, independently of the screenshot storing/discarding process, the processes (e.g., the screenshot acquiring process, the preview image displaying process, and the preview image moving process) other than the screenshot storing/discarding process. That is, the smartphone 1 can carry out at least one of the screenshot acquiring process, the preview image displaying process, and the preview image moving process, instead of carrying out the screenshot storing/discarding process.

[Flow of Process from Acquisition to Storing/Discarding of Screenshot]

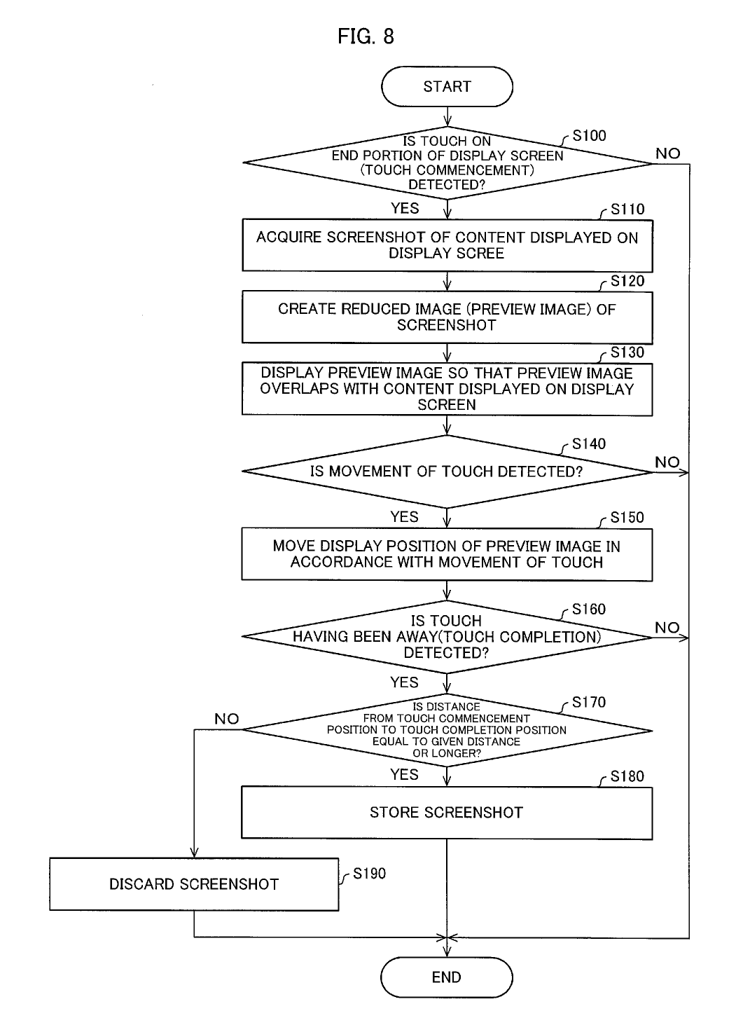

The smartphone 1 can consecutively carry out the following four processes which have been described, i.e., the screenshot acquiring process, the preview image displaying process, the preview image moving process, and the screenshot storing/discarding process. FIG. 8 is a flowchart illustrating an example of how the processes illustrated in FIGS. 4 through 7 are consecutively carried out. Specifically, in a case where the smartphone 1 detects a touch (touch commencement) on an end portion of the display section 21 (YES in S100), it acquires a screenshot of content displayed on the display section 21 (S110). Subsequently, the smartphone 1 creates a preview image of the screenshot thus acquired (S120), and then displays the preview image so that the preview image overlaps with the content displayed on the display section 21 (S130). In a case where, after displaying the preview image, the smartphone 1 detects the touch having moved, from the end portion of the display section 21, along the upper side of the display section 21 (YES in S140), the smartphone 1 moves a display position of the preview image in accordance with a movement of the touch (S150). Thereafter, in a case where the smartphone 1 detects the touch having been away from the upper side of the display section 21 (YES in S160), the smartphone 1 carries out the following processes. That is, the smartphone 1 determines whether or not a distance from the touch commencement position to the touch completion position is equal to a given distance or longer (S170). In a case where the distance from the touch commencement position to the touch completion position is equal to the given distance or longer (YES in S170), the smartphone 1 stores the screenshot (S180). Meanwhile, in a case where the distance from the touch commencement position to the touch completion position is shorter than the given distance (NO in S170), the smartphone 1 discards the screenshot (S190).

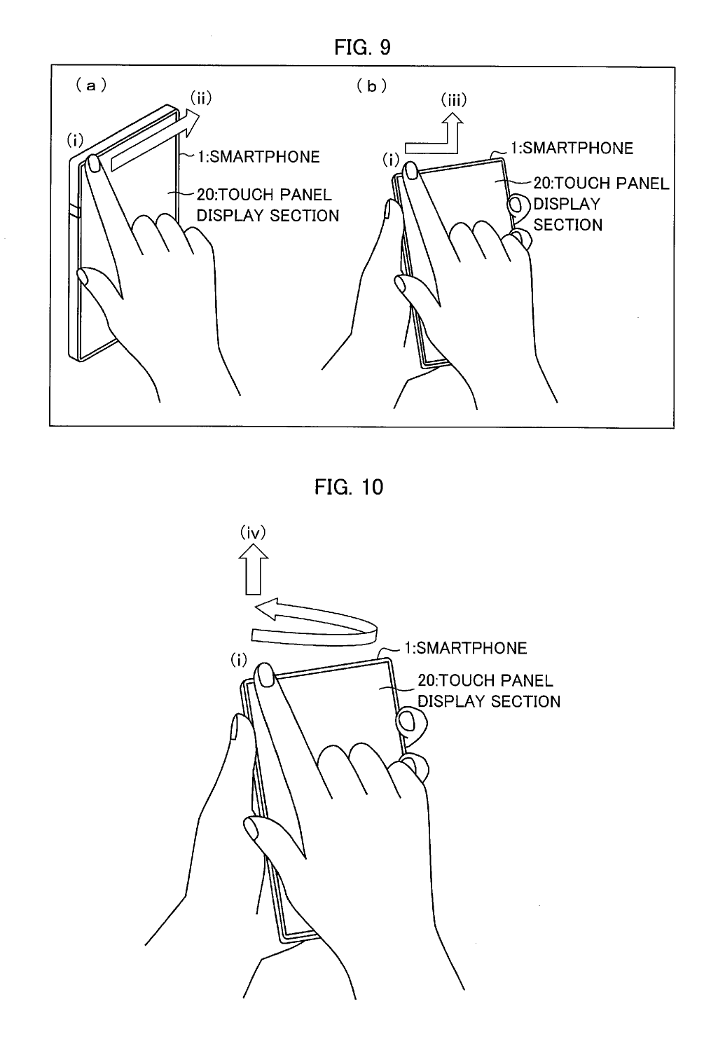

(a) of FIG. 9 is a view illustrating an example of a user's operation of acquiring a screenshot and then storing the screenshot. (b) of FIG. 9 is a view illustrating an example of a user's operation of discarding an acquired screenshot. As illustrated in (a) of FIG. 9, in a case where the user touches an end portion of the display section 21 ((i) in (a) of FIG. 9), a screenshot of content displayed on the display section 21 is acquired. Thereafter, in a case where the user moves, by a given distance or longer, the touch along the upper side of the display section 21 ((ii) in (a) of FIG. 9), the screenshot is stored. Meanwhile, in a case where a finger, with which the user has touched the end portion of the display section 21, is away from the upper side of the display section 21 before the finger is moved by the given distance ((iii) in (b) of FIG. 9), the screenshot is discarded (i.e., storing of the screenshot is cancelled).

### Embodiment 2

In the above example, the smartphone 1 is configured to discard the screenshot in a case where the touch is away from the upper side of the display section 21 before the touch is moved, by the given distance or longer, from the position (touch commencement position) at which the touch on an end portion of the display section 21 was commenced, along the upper side of the display section 21. However, a smartphone 1 of Embodiment 2 also discards the screenshot in a case where it detects a user's operation that will be discussed below, for example, with reference to FIG. 10. FIG. 10 is a view illustrating a user's operation of discarding an acquired screenshot, which user's operation is different from that illustrated in (b) of FIG. 9. “(iv)” of FIG. 10 indicates an operation in which a touch on an end portion of the display section 21 is (a) moved, by a given distance, from a position (touch commencement position) at which the touch was commenced, along the upper side of the display section 21, (b) turned back, by a distance which is shorter than the given distance, and (c) then away from the upper side of the display section 21. The smartphone 1 cancels storing of a screenshot in a case where a distance (i) from the position (touch commencement position), at which the touch on the end portion of the display section 21 was commenced, (ii) to the position (touch completion position), at which the touch was away from the upper side of the display section 21, is shorter than a given distance. As such, the user can discard a screenshot, acquired by touching the end portion of the display section 21, by conducting the operation (iv) illustrated in FIG. 10. Namely, even after the user has traced, with a finger, the upper side of the display section 21 by the given distance or longer, the user can cancel storing of the screenshot by (i) turning back the finger by a distance which is shorter than the given distance and then (ii) causing the finger to be away from the upper side of the display section 21.

### Embodiment 3

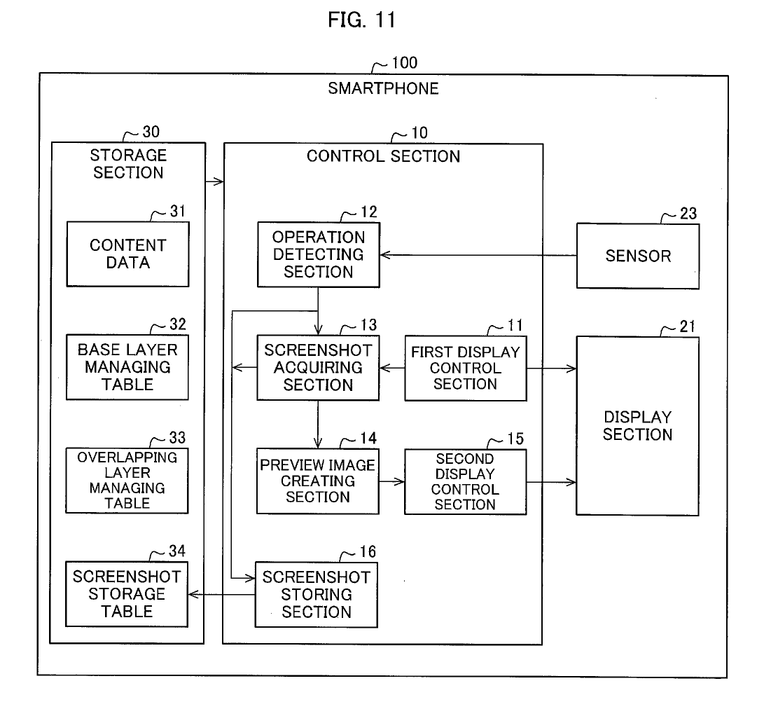

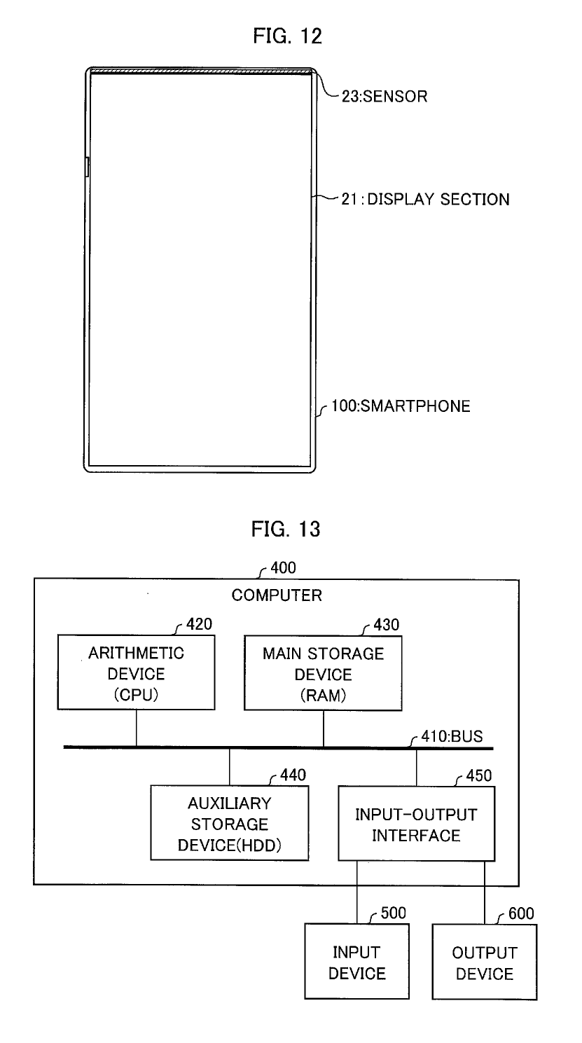

According to the smartphone 1 of Embodiments 1 and 2, the operation input section 22, which is a touch panel provided so as to overlap with the display section 21, acquires a touch on an end portion of the display section 21. However, how to acquire a touch on an end portion of the display section 21 can be alternatively determined in accordance with a specification of a device to be used, and is therefore not limited to the above example configuration. A smartphone 100 (display control device) in accordance with Embodiment 3 includes a sensor 23 for acquiring a touch on an end portion of a display section 21. The sensor 23 is provided along an upper side of the display section 21. FIG. 11 is a block diagram illustrating a main configuration of the smartphone 100. The smartphone 100 includes the sensor 23 for acquiring a touch on an end portion of the display section 21, instead of the operation input section 22 of the smartphone 1. Except for the above point, the smartphone 100 is similar to the smartphone 1, and thus descriptions will be omitted. FIG. 12 is a view illustrating an example of how to provide, in the smartphone 100, the sensor 23 for acquiring a touch on an end portion of the display section 21. According to the smartphone 100, the sensor 23 is provided along the upper side of the display section 21 so as to acquire a touch on an end portion of the display section 21. Note that the sensor 23 illustrated in FIG. 12 has a belt-like shape, specifically has a linear shape, so as to be provided along the upper side of the display section 21. Note that the shape and configuration of the sensor 23 are not limited as such. For example, a group of sensors including a plurality of sensors, which are intermittently provided along the upper side of the display section 21, can be employed as the sensor 23.

### Embodiment 4

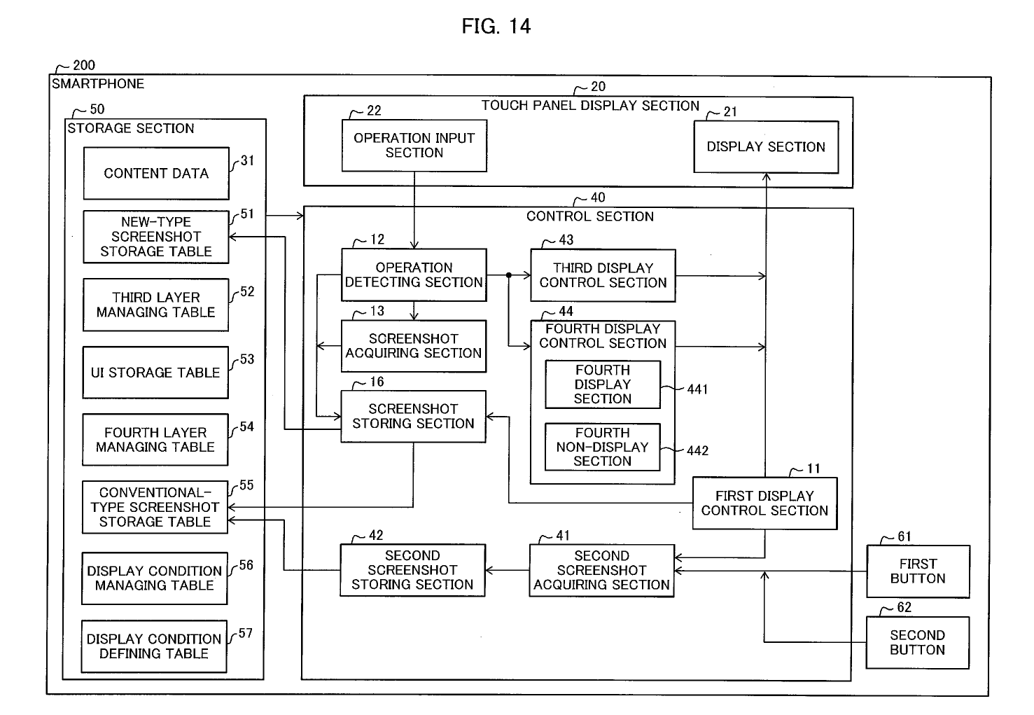

Embodiment 4 of the present invention will be discussed below with reference to FIGS. 14 through 19. For convenience, members having functions identical to those discussed in Embodiments 1 through 3 are given identical reference numerals, and descriptions of such members are omitted.

(Method of Acquiring Two Types of Screenshots)

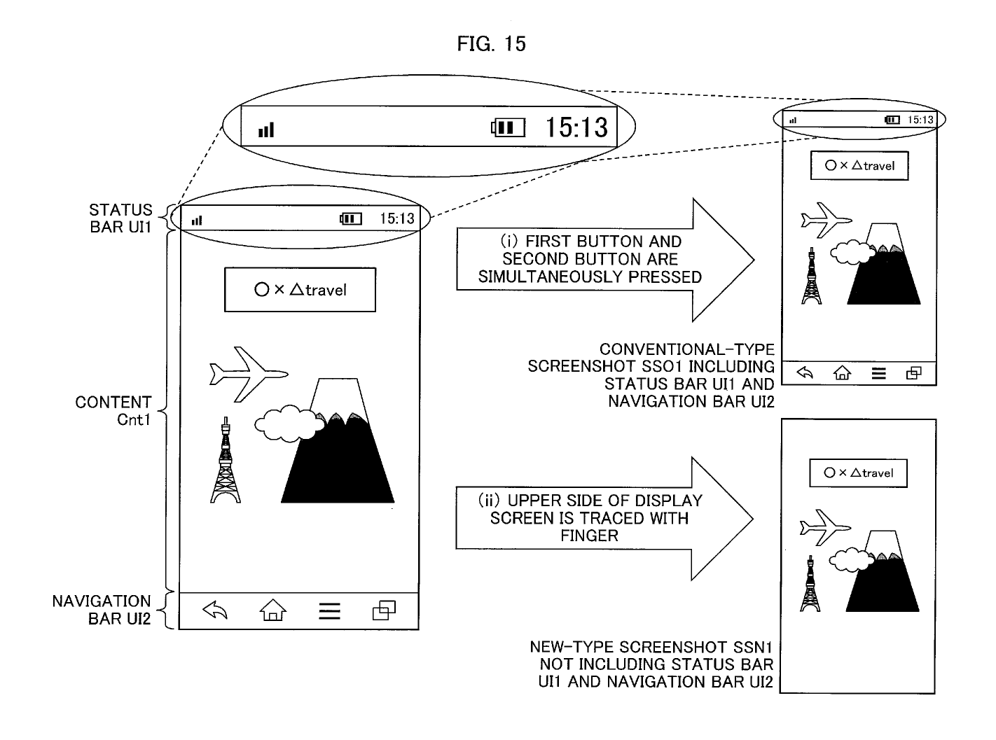

A smartphone 200 (display control device) in accordance with Embodiment 4 can store two types of screenshots, which will be first discussed below with reference to FIG. 15. In response to two types of respective user's operations for acquiring and storing a screenshot, the smartphone 200 acquires and stores a new-type screenshot SSN1 or a conventional-type screenshot SSO1 (see FIG. 15). The “new-type screenshot” is a screenshot of an image that does not include a status bar UI1 and a navigation bar UI2, i.e., a screenshot that does not include the status bar UI1 and the navigation bar UI2. In contrast, the “conventional-type screenshot” includes the status bar UI1 and the navigation bar UI2. Note that the status bar UI1 is a region in which, for example, (i) a status of the smartphone 200 and (ii) notification information (e.g., information about radiowave condition, time, residual battery power, etc. of the smartphone 200) are displayed. The status bar UI1 is displayed at, for example, an upper part of the display section 21. The navigation bar UI2 is a region in which, for example, (i) a title of a page which is being displayed on the display section 21 and (ii) software buttons such as a home button and a return button are displayed. The navigation bar UI2 is displayed at, for example, a bottom part of the display section 21. In a case where the smartphone 200 detects a first button 61 and a second button 62 having been simultaneously pressed as illustrated in “(i)” of FIG. 15, the smartphone 200 acquires and stores a conventional-type screenshot SSO1. Specifically, the smartphone 200 includes the first button 61 and the second button 62. In a case where the smartphone 200 detects the first button 61 and the second button 62 having been simultaneously pressed, it acquires a screenshot (conventional-type screenshot SSO1) of an image that (i) the first display control section 11 controls the display section 21 to display and (ii) includes the status bar UI1 and the navigation bar UI2. Note here that an image of the status bar UI1, included in the conventional-type screenshot SSO1, indicates that (i) an acquisition time of the conventional-type screenshot SSO1 is “15:13” and (ii) a radiowave condition of the smartphone 200 is indicated by “three lines” at the acquisition time. The smartphone 200 stores the conventional-type screenshot SSO1 thus acquired in a conventional-type screenshot storage table 55. Note that, for example, a “power button” and a “turn-down button”, which are also included in a conventional smartphone, can also be employed as the first button 61 and the second button 62, respectively.

As illustrated in “(ii)” of FIG. 15, in a case where the smartphone 200 detects a touch on an end portion of the display section 21, it acquires a new-type screenshot SSN1 as with the smartphone 1. That is, the smartphone 200 acquires a screenshot (new-type screenshot SSN1) of an image that (i) the first display control section 11 controls the display section 21 to display and (ii) does not include the status bar UI1 and the navigation bar UI2. Thereafter, in a case where the smartphone 200 detects the touch having been moved along the upper side of the display section 21 by a given distance or longer and having been away from the upper side, it stores the new-type screenshot SSN1 in a new-type screenshot storage table 51 and in the conventional-type screenshot storage table 55.

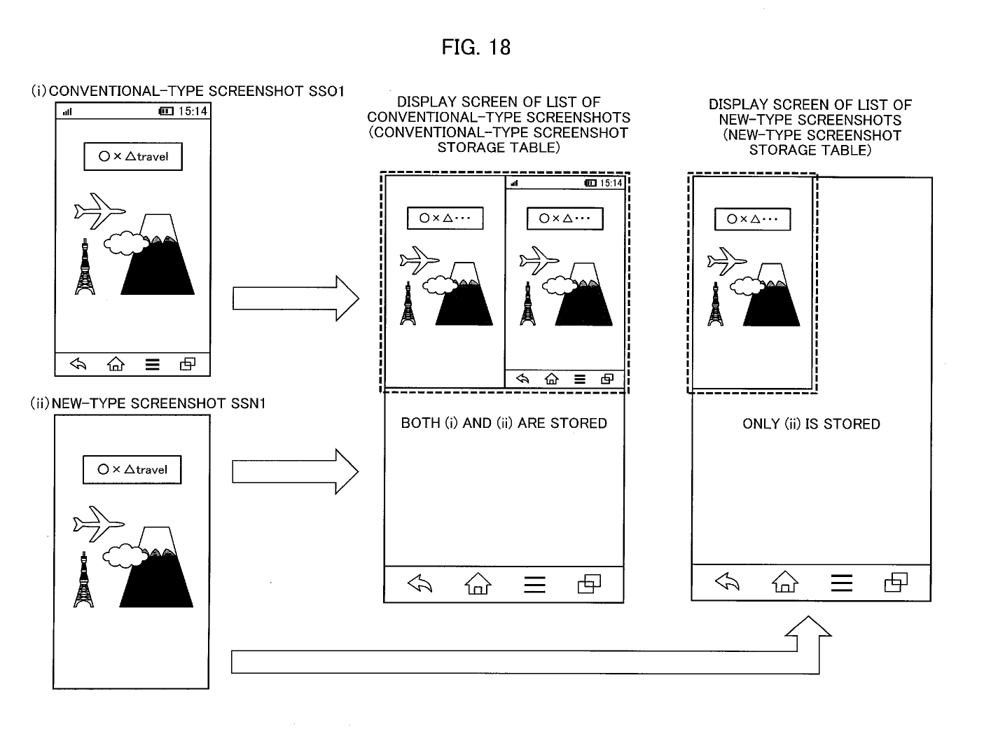

The screenshots acquired by the two types of user's operations can be summarized as follows. That is, in a case where the smartphone 200 detects the first button 61 and the second button 62 having been simultaneously pressed, it acquires the conventional-type screenshot SSO1 of an image being displayed on the display section 21, the conventional-type screenshot SSO1 including the status bar UI1 and the navigation bar UI2. In contrast, in a case where the smartphone 200 detects a touch, commenced from an end portion of the display section 21, having been moved along the upper side of the display section 21 by a given distance or longer and having been away from the upper side, it acquires the new-type screenshot SSN1 of the image being displayed on the display section 21. The new-type screenshot SSN1 is a screenshot of content Cnt1, which the first display control section 11 controlled the display section 21 to display at a time point when the touch on the end of the display section 21 was commenced and which does not include the status bar UI1 and the navigation bar UI2. As illustrated in FIG. 18, the new-type screenshot SSN1 is to be stored in the new-type screenshot storage table 51 and in the conventional-type screenshot storage table 55. The conventional-type screenshot SSO1 is to be stored in the conventional-type screenshot storage table 55. That is, only the new-type screenshots is to be stored in the new-type screenshot storage table 51.

(Switching Between Display and Non-Display of GUI on New-Type Screenshot)

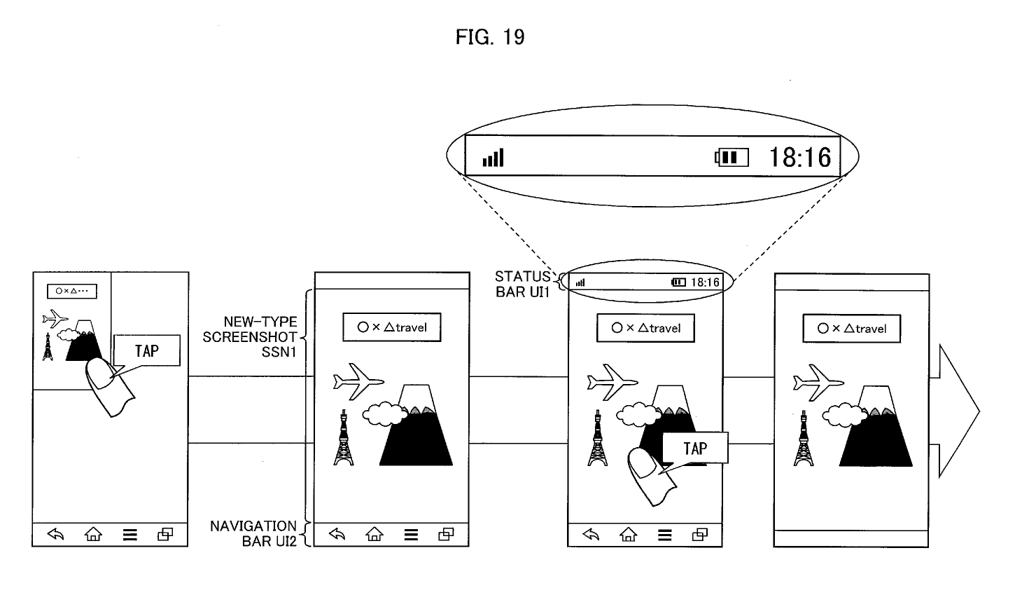

FIG. 19 is a view illustrating how a display screen of the smartphone 200 undergoes transitions in response to a user's operation. A leftmost screen illustrated in FIG. 19 is an example of a screen (list screen) indicating a list of new-type screenshots stored in the new-type screenshot storage table 51. The list screen indicates a reduced image of the new-type screenshot SSN1 acquired in “(ii)” of FIG. 15, the new-type screenshot SSN1 not including the status bar UI1 and the navigation bar UI2. In a case where the smartphone 200 detects a tap on the reduced image of the new-type screenshot SSN1 in the list screen, it undergoes a transition into a second screen from the left of FIG. 19. That is, the smartphone 200 displays the new-type screenshot SSN1 in a full-screen mode, and displays the navigation bar UI2 so that it overlaps with the new-type screenshot SSN1 thus displayed in the full-screen mode. Thereafter, the screen displayed on the display section 21 undergoes a transition into a third screen from the left of FIG. 19. That is, the smartphone 200 displays the status bar UI1 and the navigation bar UI2 so that they overlap with the new-type screenshot SSN1. Specifically, the smartphone 200 displays the status bar UI1 such that the status bar UI1 gradually comes down from the uppermost part of the display section 21 so as to overlap with the new-type screenshot SSN1. Note that, as illustrated in “(i)” of FIG. 15, the acquisition time of the conventional-type screenshot SSO1 is indicated by “15:13” and the radiowave condition of the smartphone 200 is indicated by “three lines” at the acquisition time. Meanwhile, in the third screen, the status bar UI1, which is displayed so as to overlap with the new-type screenshot SSN1, indicates that (i) the current time is “18:16” and (ii) the radiowave condition of the smartphone 200 is currently indicated by “four lines.” In a case where the smartphone 200 detects a tap on the new-type screenshot SSN1 in the third screen, the screen displayed on the display section 21 undergoes a transition into a fourth screen from the left of FIG. 19. It follows that the smartphone 200 hides the status bar UI1 and the navigation bar UI2 that have been displayed so as to overlap with the new-type screenshot SSN1. Alternatively, the smartphone 200 can be configured so that the screen displayed on the display section 21 undergoes a transition into the third screen, in a case where the smartphone 200 detects a tap on the new-type screenshot SSN1 in the second screen displayed on the display section 21.

Note that in a case where the smartphone 200 undergoes a transition from the second screen into the third screen, displaying the status bar UI1 is not limited to the above-described display style. In a case where the smartphone 200 detects, for example, a tap on the new-type screenshot SSN1 in the leftmost screen as described above, the smartphone 200 can alternatively (i) undergo a transition into the second screen and then (ii) automatically display the status bar UI1 so that the status bar UI1 gradually comes down from an uppermost part of the display section 21 so as to overlap with the new-type screenshot SSN1 (like an animation) as illustrated in the third screen. The smartphone 200 can alternatively display the status bar UI1 illustrated in the third screen so that the status bar UI1 appears from a right side of the display section 21 and moves toward a left side of the display section 21. That is, the smartphone 200 can display the status bar UI1 in any manner, provided that (i) display of the status bar UI1 illustrated in the third screen changes over time and (ii) display of the new-type screenshot SSN1 illustrated in the second screen does not change over time.

The above outline of the smartphone 200 can be summarized as follows. That is, the smartphone 200 includes (i) a third display control section 43 (screenshot display section) controlling the display section 21 to display a new-type screenshot SSN1 (first screenshot) of an image that was displayed on the display section 21 (display screen) and (ii) a fourth display section 441 (GUI display section) for displaying the status bar UI1 and the navigation bar UI2 so that they overlap with the new-type screenshot SSN1 which the third display control section 43 controls the display section 21 to display. Note that a screenshot that the third display control section 43 controls the display section 21 to display is preferably a new-type screenshot SSN1. Instead, the third display control section 43 can control the display section 21 to display a conventional-type screenshot SSO1. That is, either a new-type screenshot SSN1 or a conventional-type screenshot SSO1 can be displayed behind each of the status bar UI1 and the navigation bar UI2, which the fourth display section 441 controls the display section 21 to display. Note that the following description will discuss an example in which (i) the third display control section 43 controls the display section 21 to display a new-type screenshot SSN1 and (ii) the fourth display section 441 controls the display section 21 to display the status bar UI1 and the navigation bar UI2 so that they overlap with the new-type screenshot SSN1.

The smartphone 200 displays the new-type screenshot SSN1, which is a screenshot of an image obtained by removing the status bar UI1 and the navigation bar UI2 from an image that was displayed on the display section 21 at a time point when the screenshot was acquired. In a case where, for example, the smartphone 200 is to display a screenshot of content Cnt1 that was displayed on the display section 21, it does not display the status bar UI1 and the navigation bar UI2, which were displayed on the display section 21 together with the content Cnt1 at a time point when the screenshot was acquired. Note here that screenshots of respective of the status bar UI1 and the navigation bar UI2 are mere images that cannot be operated by the user, and are thus considered to be unnecessary for the user who attempts to view the screenshot of the content Cnt1. By employing the smartphone 200, the user can view, through the display section 21, an intended screenshot of the content Cnt1, from which screenshots of the status bar UI1 and the navigation bar UI2 that a user cannot operate are removed.

The smartphone 200 can display the status bar UI1 and the navigation bar UI2 so that they overlap with the new-type screenshot SSN1. This allows the user to make use of the status bar UI1 and the navigation bar UI2 while the new-type screenshot SSN1 is being displayed on the display section 21.

The conventional-type screenshot SSO1 includes the screenshots of the status bar UI1 and the navigation bar UI2 that were displayed on the display section 21 at a time point when the conventional-type screenshot SSO1 was acquired. Since the screenshots of the status bar UI1 and the navigation bar UI2 are mere images as has been described, it is not possible for the user to make use of the screenshots of the status bar UI1 and the navigation bar UI2. In a case where the conventional-type screenshot SSO1 is displayed, the screenshots of the status bar UI1 and the navigation bar UI2, which screenshots cannot be operated by the user, are also displayed on the display section 21. In such a case, the user sometimes attempts, erroneously, to operate the screenshots of the status bar UI1 and the navigation bar UI2. In contrast, by employing the smartphone 200, the user can use the status bar UI1 and the navigation bar UI2 that are displayed so as to overlap with the new-type screenshot SSN1.

Note that the GUIs, which are to be displayed by the smartphone 200 so as to overlap with the new-type screenshot SSN1, include a status bar for indicating information about conditions of the smartphone 200 and the like. This allows the user to check the information about conditions of the smartphone 200 and the like, while viewing the new-type screenshot SSN1. Note, however, that the new-type screenshot SSN1 is not essentially a screenshot of an image from which the status bar UI1 and the navigation bar UI2 are removed.

As is shown in a transition from the second screen to the third screen, the fourth display section 441 controls the display section 21 so that (i) the status bar UI1 gradually comes down from the uppermost part of the display section 21 so as to overlap with the new-type screenshot SSN1.

The smartphone 200 further includes (i) an operation detecting section 12 (detection section) for detecting a tap (user's operation) on the new-type screenshot SSN1 and (ii) a fourth non-display section 442 (display switching section) which hides the status bar UI1 and the navigation bar UI2 that are displayed on the fourth display section 441, in a case where the operation detecting section 12 detects a tap on the new-type screenshot SSN1. That is, the smartphone 200 switches, in response to a user's operation with respect to the new-type screenshot SSN1, between display and non-display of each of the status bar UI1 and the navigation bar UI2. This allows the user to hide the status bar UI1 and the navigation bar UI2 in a case where the user wants to view the new-type screenshot SSN1 without disturbance of the status bar UI1 and the navigation bar UI2. Furthermore, the user can also cause the status bar UI1 and the navigation bar UI2 to be displayed on the display section 21 in a case where the user wants to operate the status bar UI1 and the navigation bar UI2.

[Device Configuration]

A configuration of the smartphone 200 will be discussed below with reference to FIG. 14. FIG. 14 is a block diagram illustrating an example of a main configuration of the smartphone 200 in accordance with Embodiment 4. As illustrated in FIG. 14, the smartphone 200 includes a control section 40, a touch panel display section 20, and a storage section 50. The smartphone 200 differs from the smartphone 1 illustrated in FIG. 1 in that it further includes a first button and a second button 62. In a case where a second screenshot acquiring section 41 of the control section 40 of the smartphone 200 detects the first button 61 and the second button 62 having been simultaneously pressed, it acquires an image from a first display control section 11 as below. That is, the second screenshot acquiring section 41 acquires an image (i) that the first display control section 11 controls a display section 21 to display and (ii) that includes a status bar UI1 and a navigation bar UI2. The second screenshot acquiring section 41 then (i) creates a screenshot of the image including the status bar UI1 and the navigation bar UI2, i.e., a conventional-type screenshot SSO1 and (ii) notifies a second screenshot storing section 42 of the conventional-type screenshot SSO1 thus created. The second screenshot storing section 42 stores, in a conventional-type screenshot storage table 55, the conventional-type screenshot SSO1 thus notified by the second screenshot acquiring section 41.

In a case where an operation detecting section 12 detects a touch on an end portion of the display section 21, a screenshot acquiring section 13 acquires a new-type screenshot SSN1 of an image which the first display control section 11 controls the display section 21 to display. That is, the screenshot acquiring section 13 acquires, from the first display control section 11, an image (i) that the display section 21 had displayed at a time point when the operation detecting section 12 detected a commencement of a touch on an end portion of the display section 21 and (ii) that does not include the status bar UI1 and the navigation bar UI2. For example, the screenshot acquiring section 13 acquires, from the first display control section 11, content Cnt1, which the first display control section 11 had controlled the display section 21 to display at a time point when the operation detecting section 12 detected a commencement of a touch on an end portion of the display section 21. The screenshot acquiring section 13 then (i) creates a screenshot (new-type screenshot SSN1) of the content Cnt1 and (ii) notifies a screenshot storing section 16 of the new-type screenshot SSN1 thus created. In a case where the content Cnt1 is a web page, the screenshot acquiring section 13 further notifies the screenshot storing section 16 of (i) a title of the web page and (ii) a URL of the web page. In a case where the operation detecting section 12 notifies the screenshot storing section 16 of “a touch that had been commenced from an end portion of the display section 21 was moved, by a given distance or longer, along the upper side of the display section 21 and was then away from the upper side,” the screenshot storing section 16 conducts the following operation. That is, the screenshot storing section 16 stores, in a new-type screenshot storage table 51 and the conventional-type screenshot storage table 55, the new-type screenshot SSN1 thus notified by the screenshot acquiring section 13. Note that in a case where the screenshot acquiring section 13 notifies the screenshot storing section 16 of, together with the new-type screenshot SSN1, the title of the content Cnt1 and the URL of the content Cnt1 on which the new-type screenshot SSN1 is based, the screenshot storing section 16 stores, in the new-type screenshot storage table 51, the title and the URL together with the new-type screenshot SSN1.

A third display control section 43 controls the display section 21 to display a new-type screenshot SSN1 and a conventional-type screenshot SSO1. For example, the third display control section 43 controls the display section 21 to display the new-type screenshot SSN1 that is stored in the new-type screenshot storage table 51 (later described). A fourth display control section 44 controls switching between display and non-display of the status bar UI1 and the navigation bar UI2. The fourth display control section 44 includes a fourth display section 441 and a fourth non-display section 442. The fourth display section 441 displays the status bar UI1 and the navigation bar UI2 so that they overlap with the new-type screenshot SSN1 which the third display control section 43 controls the display section 21 to display. The fourth non-display section 442 hides the status bar UI1 and the navigation bar UI2, which are displayed by the fourth display section 441 so as to overlap with the new-type screenshot SSN1. As such, the fourth display control section 44 controls switching between display and non-display of each of the status bar UI1 and the navigation bar UI2, in accordance with (i) a display condition (display condition ID) of the new-type screenshot SSN1 and (ii) a user's operation with respect to the new-type screenshot SSN1 (later described in detail).

[Data to be Stored in Storage Section]

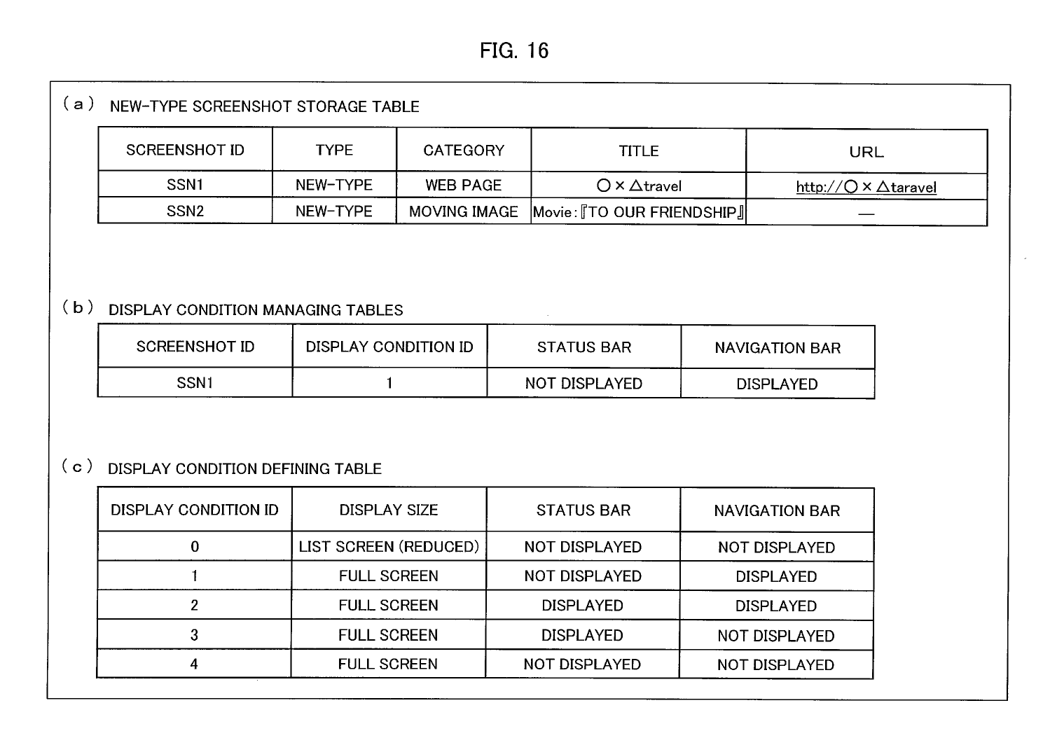

The storage section 50 includes (i) content data 31, (ii) a new-type screenshot storage table 51, (iii) a third layer managing table 52, (iv) a UI storage table 53, (v) a fourth layer managing table 54, (vi) a conventional-type screenshot storage table 55, (vii) a display condition managing table 56, and (viii) a display condition defining table 57. FIG. 16 is a view illustrating an example of data stored in the storage section 50 of the smartphone 200. The new-type screenshot storage table 51 stores therein the new-type screenshot SSN1. In a case where the new-type screenshot SSN1 is a screenshot of a web page, a title of the web page and a URL of the web page are stored in the new-type screenshot storage table 51 together with the new-type screenshot SSN1 (see (a) of FIG. 16).

The third layer managing table 52 stores therein information that is used in a case where the third display control section 43 controls the display section 21 to display the new-type screenshot SSN1 and the conventional-type screenshot SSO1. The fourth layer managing table 54 stores therein information that is used in a case where the fourth display control section 44 controls switching between display and non-display of each of the status bar UI1 and the navigation bar UI2. Note that (i) a layer intended for the third display control section 43 to control the display section 21 to display the new-type screenshot SSN1 and the conventional-type screenshot SSO1 and (ii) a layer intended for the fourth display control section 44 to control the display section 21 to display the status bar UI1 and the navigation bar UI2, differ from each other. Hereinafter, a layer intended for the third display control section 43 will be referred to as a third layer, whereas a layer intended for the fourth display control section 44 will be referred to as a fourth layer. Note here that (i) a single layer can serve both as the third layer and the base layer of Embodiment 1 and (ii) a single layer can serve both as the fourth layer and the overlapping layer of Embodiment 1. The UI storage table 53 stores therein the status bar UI1 and the navigation bar UI2 which the fourth display control section 44 controls switching between display and non-display.

The conventional-type screenshot storage table 55 stores therein the conventional-type screenshot SSO1. The display condition managing table 56 manages, for each new-type screenshot SSN1 displayed on the display section 21 (i.e., for each screenshot ID), (i) a display size of the new-type screenshot SSN1 and (ii) display and non-display of each of the status bar UI1 and the navigation bar UI2. Note that the “display condition ID” is an item defined by the display condition defining table 57 (later described in detail). The display condition defining table 57 defines the display condition ID by associating the display condition ID with both of (i) the display size (list screen mode or full-screen mode) of the new-type screenshot SSN1 and (ii) display/non-display of each of the status bar UI1 and the navigation bar UI2. For example, in the display condition defining table 57 illustrated in (c) of FIG. 16, the display condition ID=1 is associated with both of (i) the display size=full-screen mode, (ii) the status bar=non-display, and (iii) the navigation bar=display. Thus, the display condition managing table 56 illustrated in (b) of FIG. 16 indicates that (i) the screenshot ID of a screenshot displayed on the display section 21 is “SSN1” and (ii) the display condition ID of that screenshot is “1.” To put it another way, the display condition managing table 56 illustrated in (b) of FIG. 16 indicates “(i) the new-type screenshot SSN1 is displayed on the display section 21 in a display size, i.e., in a full-screen mode, (ii) the status bar UI1 is not displayed (non-display), and (iii) the navigation bar UI2 is displayed.”

(Method of Controlling Display of New-Type Screenshot)

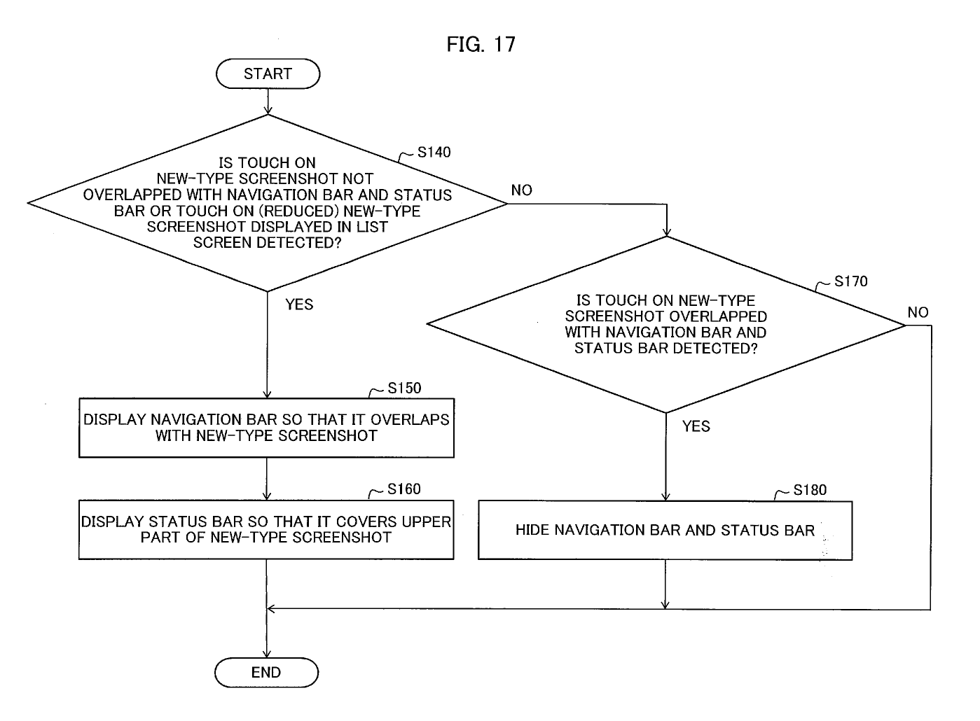

FIG. 17 is a flowchart illustrating an example of how the smartphone 200 switches, in response to a user's operation, between display and non-display of each of the status bar UI1 and the navigation bar UI2. The smartphone 200 determines whether or not it has detected (i) a touch on a new-type screenshot SSN1 that is not overlapped with the navigation bar UI2 and the status bar UI1 or (ii) a touch on a (reduced) new-type screenshot SSN1 that is being displayed in a list screen (S140). In a case where the smartphone 200 detects (i) a touch on a new-type screenshot SSN1 that is not overlapped with the navigation bar UI2 and the status bar UI1 or (ii) a touch on a (reduced) new-type screenshot SSN1 that is displayed in a list screen (YES in S140), the smartphone 200 first displays the navigation bar UI2 so that the navigation bar UI2 overlaps with the new-type screenshot SSN1 (S150). In other words, the smartphone 200 determines whether or not the new-type screenshot SSN1, the status bar UI1, and the navigation bar UI2 are displayed in conditions where “display condition=0 or 4” is defined in a table defining display conditions illustrated in (c) of FIG. 16. The smartphone 200 displays the navigation bar UI2 so that the navigation bar UI2 overlaps with the new-type screenshot SSN1, in a case where (i) the display conditions of (a) the new-type screenshot SSN1, (b) the status bar UI1, and (c) the navigation bar UI2 match the conditions defined in such a table as “display condition=0 or 4” as illustrated in (c) of FIG. 16 and (ii) the smartphone 200 detects a touch on the new-type screenshot SSN1 (S150). After S150, the smartphone 200 further displays the status bar UI1 so that the status bar UI1 fully overlaps the new-type screenshot SSN1 (S160).

The smartphone 200 makes a determination in S170, in a case where the smartphone 200 detects none of (i) a touch on a new-type screenshot SSN1 that does not overlap with each of the navigation bar UI2 and the status bar UI1 and (ii) a touch on a (reduced) new-type screenshot SSN1 that is displayed in a list screen. It follows that the smartphone 200 determines whether or not a touch, on a new-type screenshot SSN1 that overlaps with each of the navigation bar UI2 and the status bar UI1, is detected (S170). In other words, the smartphone 200 determines whether or not a touch on the new-type screenshot SSN1 is detected, in a case where the display conditions (non-display conditions) of (i) the new-type screenshot SSN1, (ii) the status bar UI1, and (iii) the navigation bar UI2 match the conditions defined as “display condition=2” in the table illustrated in (c) of FIG. 16. In a case of YES in S170, the smartphone 200 hides the navigation bar UI2 and the status bar UI1 (S180). That is, the fourth non-display section 442 hides the status bar UI1 and the navigation bar UI2, which are displayed on the fourth display section 441 so that they overlap with the new-type screenshot SSN1. In a case of NO in S170, the smartphone 200 terminates the process. Note that the smartphone 200 can alternatively terminate the process in S160, in a case where a touch, on the new-type screenshot SSN1 overlapped with the navigation bar UI2, is detected after the process in S150.

### Embodiment 5

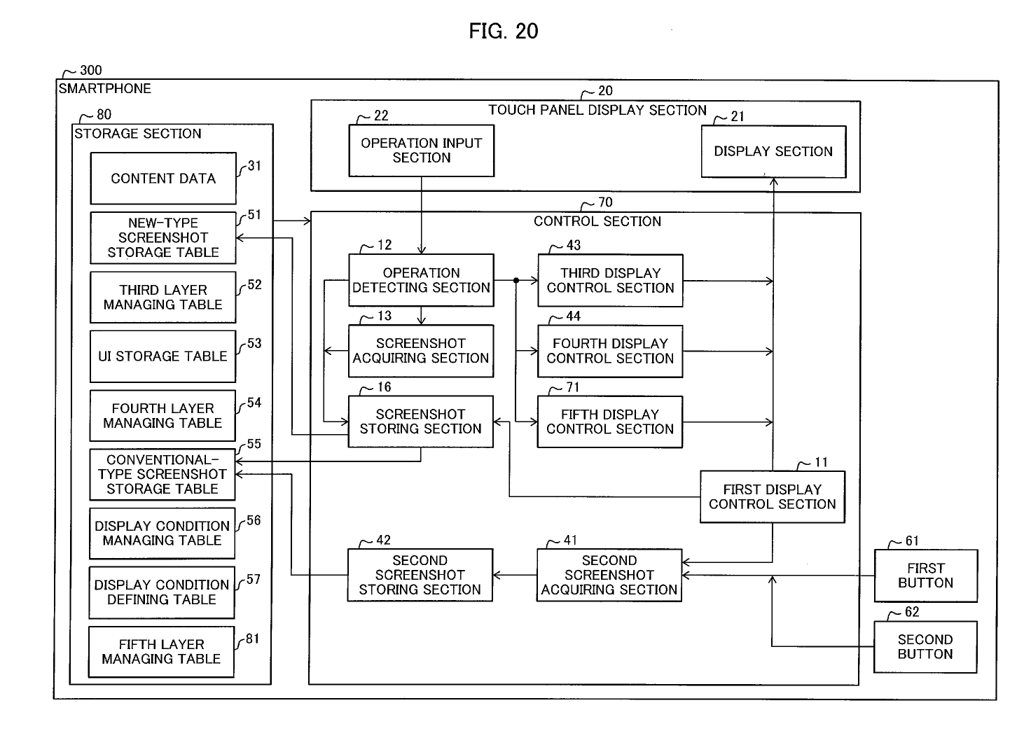

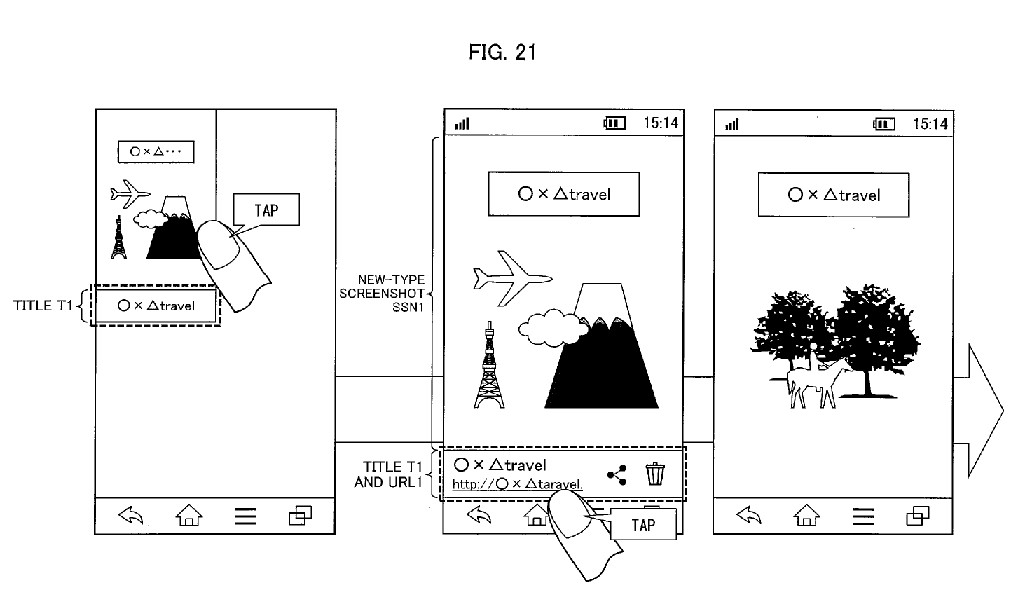

The following description will discuss Embodiment 5 of the present invention with reference to FIGS. 20 and 21. Note that for convenience, members having functions identical to those discussed in Embodiments 1 through 4 are given identical reference numerals, and descriptions of such members are omitted. An outline of a smartphone 300 (display control device) in accordance with Embodiment 5 will be first discussed below. That is, in a case where the smartphone 300 detects a user's operation of acquiring and storing a screenshot of a web page displayed on the display section 21, the smartphone 300 stores the screenshot of the web page together with a title of the web page and a URL of the web page. The web page as used herein indicates content on the network, and is a cluster of data displayed on a browser at a time. Note that not only the smartphone 300 but also each of the smartphones 1, 100, and 200 can have such a function of storing a URL of the web page, together with a screenshot of a web page.

(How Screen Undergoes Transition in Case where New-Type Screenshot is Web Page)

How a display screen of the smartphone 300 undergoes a transition will be discussed below with reference to FIG. 21. FIG. 21 is a view illustrating how a display screen of the smartphone 300 undergoes a transition in response to a user's operation. A leftmost screen illustrated in FIG. 21 is an example of a list screen indicating a list of new-type screenshots stored in a new-type screenshot storage table 51. Note that, as discussed earlier, in a case where a new-type screenshot SSN1 is a screenshot of a web page, the new-type screenshot storage table 51 stores a title of the web page and a URL of the web page together with the new-type screenshot SSN1. The list screen indicates a reduced image of the new-type screenshot SSN1 acquired in “(ii)” of FIG. 15, and a lower part of the new-type screenshot SSN1 overlaps with the title T1 of the web page. In a case where the smartphone 300 detects a tap on the reduced image of the new-type screenshot SSN1 in the list screen, it undergoes a transition into a second screen from the left of FIG. 21. That is, the smartphone 300 (i) displays the new-type screenshot SSN1 in a full-screen mode (screenshot displaying step), and (ii) displays the title T1 of the web page and a URL 1 of the web page so that they overlap with the lower part of the new-type screenshot SSN1 thus displayed in the full-screen mode (web page displaying step). In a case where the smartphone 300 detects a tap on the URL 1 in the second screen, it undergoes a transition to a third screen from the left of FIG. 21. That is, in such a case, the smartphone 300 (i) starts up a browser and (ii) displays a web page indicated by the URL1 in the second screen of FIG. 21. Note that in the second screen of FIG. 2, it is also possible to display the title T1 or the URL1 so that they overlap with the new-type screenshot SSN1. In a case where the title T1 is displayed so as to overlap with the new-type screenshot SSN1, the title T1 is associated with a URL that is not displayed. In such a case, upon detection of a tap on the title T1, the smartphone 300 undergoes a transition to a screen of a web page indicated by the URL, which is associated with the title T1.

The outline of the smartphone 300 can be summarized as follows. That is, the smartphone 300 includes the third display control section 43 (screenshot display section) and a fifth display control section 71 (web page display section). The display control section 43 is configured to control the display section 21 (display screen) to display a new-type screenshot SSN1 (first screenshot), which is a screenshot of an image which was displayed on the display section 21. The fifth display control section 71 (web page display section) is configured to control the display section 21 to display, in a case where the new-type screenshot SSN1 is a screenshot of a web page which was displayed on the display section 21, at least one of a title T1 of the web page and a URL1 of the web page so that the at least one of the title T1 and the URL1 overlaps with the new-type screenshot SSN1. Note that one that is displayed behind at least one of the title T1 and the URL1 of the web page, which the fifth display control section 71 controls the display section 21 to display, can be a conventional-type screenshot SSO1. That is, the smartphone 300 can alternatively control the display section 21 to display at least one of the title T1 of and the URL1 of the web page so that the at least one of the title T1 and URL1 overlaps with the conventional-type screenshot SSO1 of the web page. This makes it possible to display the new-type screenshot SSN1 or the conventional-type screenshot SSO1 without a display region of a screenshot being reduced because of a URL of and/or a title of a web page on which the screenshot is based. Furthermore, the user can easily change a browsing target from the new-type screenshot SSN1 or the conventional-type screenshot SSO1, which is being browsed, to the web page on which the new-type screenshot SSN1 or the conventional-type screenshot SSO1 is based.

[Device Configuration]

A configuration of a smartphone 300 will be discussed below with reference to FIG. 20. FIG. 20 is a block diagram illustrating a main configuration of the smartphone 300. As illustrated in FIG. 20, the smartphone 300 includes a control section 70 and a storage section 80, instead of the control section 40 and the storage section 50 of the smartphone 200 illustrated in FIG. 14. The control section 70 further includes a fifth display control section 71 in addition to the configuration of the control section 40. The storage section 80 further includes a fifth layer managing table 81 in addition to the configuration of the storage section 50. Except for the above additional components, the smartphone 300 is similar to the smartphone 200, and thus descriptions thereof will be omitted. In a case where a new-type screenshot SSN1 is a screenshot of a web page that was displayed on a display section 21, the fifth display control section 71 controls the display section 21 to display at least one of a title T1 of the web page and a URL1 of the web page so that the at least one of the title T1 and the URL1 overlaps with the new-type screenshot SSN1. In such a case, the fifth display control section 71 controls the display section 21 to display, for example, the title, which is associated with the new-type screenshot SSN1, so that the title overlaps with the new-type screenshot SSN1 that a third display control section 43 controls the display section 21 to display through a reduced image. In a case where, for example, an operation detecting section 12 detects a tap on a new-type screenshot SSN1 displayed through a reduced image, the fifth display control section 71 controls the display section 21 to display a title and a URL, each of which is associated with the new-type screenshot SSN1, so that the title and the URL overlap with the new-type screenshot SSN1 that the third display control section 43 controls the display section 21 to display. The fifth layer managing table 81 stores therein information that the fifth display control section 71 uses to switch between display and non-display of each of a title T1 of a web page and a URL1 of the web page. Note that a layer intended for the third display control section 43 to display a new-type screenshot SSN1 and a conventional-type screenshot SSO1 is different from a layer intended for the fifth display control section 71 to display a title T1 of a web page and a URL1 of the web page. A layer intended for the third display control section 43 to carry out a process will be hereinafter referred to as a third layer, and a layer intended for the fifth display control section 71 to carry out a process will be hereinafter referred to as a fifth layer. Note that (i) a single layer can serve both as the third layer and the base layer of Embodiment 1, and (ii) a single layer can serve both as the fifth layer and the overlapping layer of Embodiment 1 or the third layer of the smartphone 200.

According to the smartphone 300, the fifth display control section 71 controls the display section 21 to display at least one of a title T1 of a web page and a URL1 of the web page, on which a new-type screenshot SSN1 is based, so that the at least one of the title T1 and the URL1 overlaps with the new-type screenshot SSN1 that the third display control section 43 controls the display section 21 to display.

[Variation]

(How to Display Preview Image so that Preview Image Overlaps with Displayed Content)

Each of the smartphones 1 and 100 through 300 can store, in the storage section 30, information (hereinafter referred to as a “map”) that indicates which one of data of a base layer or data of an overlapping layer should be displayed on the display section 21. According to, for example, the “map,” (i) “transparent” which is an attribute for displaying data of the base layer or (ii) “overlapping” which is an attribute for displaying data of the overlapping layer, is set for each of pixels constituting an image to be displayed. More specifically, a value of a pixel whose attribute is “transparent” is set to “0”, whereas a value of a pixel whose attribute is “overlapping” is set to n (where “n” is an integer of 1 or more). Content and a preview image stored in content data 31 are stored in a display data storage section (not illustrated) in accordance with the “map.” Then, a display control section (not illustrated), which includes a first display control section 11 and a second display control section 15, can control the display section 21 to display the data stored in the display data storage section. Thereafter, in a case where the smartphone 1, 100, 200, or 300 detects an operation of acquiring a screenshot (e.g., a touch on an end portion of the display section 21), the smartphone 1, 100, 200, or 300 acquires a screenshot of an image which the display control section controls the display section 21 to display.

(How to Set Detection Region for Touch on End Portion of Display Section)

In a case where the smartphone 1, 100, 200, or 300 detects the user having touched an upper left end or an upper right end (touch commencement position) of the display section 21, the smartphone 1, 100, 200, or 300 acquires a screenshot of an image (content) which the display control section controls the display section 21 to display. The smartphone then stores or discards the screenshot in accordance with whether or not a distance from the touch commencement position to the position (touch completion position), at which the touch having been moved along the upper side of the display section 21 was away from the upper side of the display section 21, is equal to a given distance or longer. That is, the user can acquire a screenshot of content displayed on the display section 21 by touching an upper left end or upper right end of the display section 21 of the smartphone 1, 100, 200, or 300. Furthermore, the user can store the screenshot by moving a finger having touched the upper left end or upper right end of the display section 21 by the given distance or longer, while keeping the finger in contact with the upper side of the operation input section 22 (i.e., by moving the finger along the upper side of the display section 21 by the given distance or longer). Note, however, that a detection region (hereinafter referred to as a “screenshot-acquiring-operation detecting region”), which can detect a user's operation of acquiring a screenshot, can be further provided on each of a lower left end and a lower right end of the display section 21. Note that the screenshot-acquiring-operation detecting region can be provided on at least one of the upper left end, the upper right end, the lower left end, and the lower right end of the display section 21. Note also that a location of the screenshot-acquiring-operation detecting region is not limited to the upper left end, the upper right end, the lower left end, or the lower right end of the display section 21, provided that the screenshot-acquiring-operation detecting region is provided at at least one point on sides with which the display section 21 is enclosed. Furthermore, a shape of the display section 21 is not limited to a rectangular shape. Alternatively, the display section 21 can have a circular shape. Note that, in a case where the display section 21 has a circular shape, the end portion of the screenshot-acquiring-operation detecting region does not mean a corner of the display section 21.

### Embodiment 6

Control blocks of the smartphone 1 and 100 through 300 (particularly, the first display control section 11, the operation detecting section 12, the screenshot acquiring section 13, the preview image creating section 14, the second display control section 15, the screenshot storing section 16, the second screenshot acquiring section 41, the second screenshot storing section 42, the third display control section 43, the fourth display control section 44, and the fifth display control section 71) can be realized by a logic circuit (hardware) provided in an integrated circuit (IC chip) or the like or can be alternatively realized by software as executed by a central processing unit (CPU). In the latter case, the smartphone 1, 100, 200, or 300 can be realized by a computer (electronic computer) as illustrated in FIG. 13. FIG. 13 is a block diagram illustrating a configuration of a computer 400 by which the smartphone 1, 100, 200, or 300 can be realized. As illustrated in FIG. 13, the computer 400 includes (i) an arithmetic device 420, (ii) a main storage device 430, (iii) an auxiliary storage device 440, and (iv) an input/output interface 450 that are connected to each other via a bus 410. Each of the arithmetic device 420, the main storage device 430, and the auxiliary storage device 440 can be realized by, for example, a CPU, a random access memory (RAM), or a hard disk drive. The main storage device 430 only needs to be realized by a computer-readable “non-transitory tangible medium” such as a tape, a disk, a card, a semiconductor memory, or a programmable logic circuit. An input device 500 and an output device 600 are connected to the input/output interface 450. The input device 500 and the output device 600 of the smartphone 1, 100, 200, or 300, for example, (i) acquire an input operation, such as a voice or letters inputted by the user, and (ii) speak to the user. The input device 500 and the output device 600 of the smartphone 1, 100, 200, or 300 further (i) receive data transmitted from other servers or devices and (ii) transmit data to other servers or devices. The auxiliary storage device 440 stores programs that cause the computer 400 to operate as the smartphone 1, 100, 200, or 300. The arithmetic device 420 causes the computer 400 to operate as sections included in the smartphone 1, 100, 200, or 300 by (i) loading, on the main storage device 430, the programs stored in the auxiliary storage device 440 and (ii) executing instructions included in the programs thus expanded on the main storage device 430. An example has been discussed above in which the computer 400 is caused to operate by use of the programs stored in the auxiliary storage device 440, which is an internal recording medium. However, the present invention can also employ programs stored in an external recording medium. Such programs can be supplied to the computer via any transmission medium (such as a communication network or a broadcast wave) that allows the programs to be transmitted. Note that the present invention can also be achieved in the form of a data signal in which the programs are embodied via electronic transmission and which is embedded in a carrier wave.

[Main Points]

A display control device (smartphones 200 and 300) in accordance with a first aspect of the present invention includes: a screenshot display section (third display control section 43) configured to control a display screen (display section 21) to display a first screenshot (new-type screenshot SSN1), the first screenshot being a screenshot of an image which was displayed on the display screen; and a web page display section (fifth display control section 71) configured to control, in a case where the first screenshot is a screenshot of a web page which was displayed on the display screen, the display screen to display at least one of a title of the web page and a URL of the web page so that the at least one of the title and the URL overlaps with the first screenshot.

With the above configuration, in a case where the first screenshot is a screenshot of a web page which was displayed on the display screen, the display control device displays at least one of a title of and a URL of the web page so that the at least one of the title and the URL overlaps with the first screenshot. This makes it possible to display a screenshot without a display region of the screenshot being reduced because of a URL of and/or a title of the web page on which the screenshot is based. This ultimately allows a user to (i) browse the first screenshot whose display region is secured and (ii) easily change a browsing target from the first screenshot, which is being displayed, to a web page on which the first screenshot is based.

A display control device in accordance with a second aspect of the present invention can be arranged to further include, in the first aspect of the present invention, a GUI (graphical user interface, status bar UI1, and navigation bar UI2) display section (fourth display section 441) configured to control the display screen to display a GUI so that the GUI overlaps with the first screenshot, the first screenshot being a screenshot of an image obtained by removing the GUI or another GUI from the image which was displayed on the display screen, the GUI including a status bar which indicates information including information of a condition of the display control device.

With the above configuration, the display control device displays the first screenshot which is obtained by removing a GUI from an image which was displayed on the display screen when the first screenshot was acquired. In a case where, for example, a screenshot of content which was displayed on the display screen is to be displayed, the display control device does not display a GUI which was displayed on the display screen together with the content when the screenshot was acquired. Note that a screenshot of the GUI is a mere image that cannot be operated by the user, and is thus considered to be unnecessary for the user who attempts to browse a screenshot of content. As such, with the display control device, the user can browse, through the display screen, a screenshot of intended content from which the screenshot of the GUI, which cannot be operated by the user, is removed. Furthermore, the display control device displays a GUI so that the GUI overlaps with the first screenshot. Thus, the user can use the GUI while the first screenshot is being displayed on the display screen.

Conventional screenshots each included a screenshot of a GUI which was displayed on a display screen when the screenshot was acquired. Since the screenshot of the GUI is a mere image, the user cannot make use of the screenshot of the GUI. Thus, in a case where the conventional screenshot is displayed, the screenshot of the GUI that cannot be operated by the user is displayed on the display screen. In such a case, the user may erroneously attempt to carry out an operation with respect to the screenshot of the GUI. In contrast, with the display control device, the user can make use of a GUI that is displayed so as to overlap with the first screenshot.

Note that the GUI that is displayed so as to overlap with the first screenshot includes a status bar which indicates information including information of a condition of the display control device. Thus, the user can check information of the display control device and the like while browsing the first screenshot.

A display control device in accordance with a third aspect of the present invention can be arranged such that, in the second aspect of the present invention, the GUI display section controls the display screen to display the status bar so that the status bar gradually comes down from an uppermost part of the display screen so as to overlap with the first screenshot.

With the above configuration, the display control device displays the status bar, which indicates information of a condition of the display control device, so that the status bar gradually comes down from the upper part of the display screen so as to overlap with the first screenshot. That is, (i) display of the status bar, which indicates information of a condition of the display control device, temporarily changes whereas (ii) display of the first screenshot does not temporarily change. This allows the user to readily recognize that information of a condition of the display control device, which information is indicated by the status bar, is different in type from the first screenshot which is being browsed.

A display control device in accordance with a fourth aspect of the present invention can be arranged to further include, in the second or third aspect of the present invention, a detecting section (operation detecting section 12) configured to detect a user's operation (tap) with respect to the first screenshot; and a display switching section (fourth non-display section 442) configured to control, in a case where the detecting section has detected the user's operation with respect to the first screenshot, the display screen to hide the GUI which the GUI display section controls the display screen to display.

With the above configuration, the display control device switches between display and non-display of the GUI in response to the user's operation with respect to the first screenshot. This allows the user to hide the GUI in a case where the user wants to browse the first screenshot without disturbance of the GUI. Furthermore, the user can cause the GUI to be displayed on the display screen in a case where the user wants to make an operation through the GUI.

A method of controlling a display in accordance with a fifth aspect of the present invention includes the steps of: (a) controlling a display screen to display a first screenshot, the first screenshot being a screenshot of an image which was displayed on the display screen; and (b) controlling, in a case where the first screenshot is a screenshot of a web page which was displayed on the display screen, the display screen to display at least one of a title of the web page and a URL of the web page so that the at least one of the title and the URL overlaps with the first screenshot. The above method brings about an effect similar to that of the display control device in accordance with the first aspect of the present invention.

The display control device in accordance with each aspect of the present invention can be realized by a computer. In such a case, the present invention encompasses (i) a control program for the display control device which program causes a computer to operate as each section of the display control device so that the display control device can be realized by the computer, and (ii) a computer-readable storage medium storing therein such a control program.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, a new technical feature can be achieved by combining technical means disclosed in different embodiments.

### INDUSTRIAL APPLICABILITY

The present invention is applicable to a display device including a detection section that can detect a touch on an end portion of a display screen.

### REFERENCE SIGNS LIST

1, 100, 200, and 300 Smartphone (display control device)
11 First display control section
12 Operation detecting section (detection section)
13 Screenshot acquiring section (acquisition section)
14 Preview image creating section (creating section)
15 Second display control section
16 Screenshot storing section (storing section)
43 Third display control section (screenshot display section)
441 Fourth display section (GUI display section)
442 Fourth non-display section (display switching section)
71 Fifth display control section (web page display section)

1: A display control device, comprising:
a screenshot display section configured to control a display screen to display a first screenshot, the first screenshot being a screenshot of an image which was displayed on the display screen; and
a web page display section configured to control, in a case where the first screenshot is a screenshot of a web page which was displayed on the display screen, the display screen to display at least one of a title of the web page and a URL of the web page so that the at least one of the title and the URL overlaps with the first screenshot.

2: A display control device as set forth in claim 1, further comprising:
a GUI (graphical user interface) display section configured to control the display screen to display a GUI so that the GUI overlaps with the first screenshot,
the first screenshot being a screenshot of an image obtained by removing the GUI or another GUI from the image which was displayed on the display screen,
the GUI including a status bar which indicates information including information of a condition of the display control device.

3: A display control device as set forth in claim 2, wherein:
the GUI display section controls the display screen to display the status bar so that the status bar gradually comes down from an uppermost part of the display screen so as to overlap with the first screenshot.

4: A display control device as set forth in claim 2, further comprising:
a detecting section configured to detect a user's operation with respect to the first screenshot; and
a display switching section configured to control, in a case where the detecting section has detected the user's operation with respect to the first screenshot, the display screen to hide the GUI which the GUI display section controls the display screen to display.

5: A method of controlling a display, comprising the steps of:
(a) controlling a display screen to display a first screenshot, the first screenshot being a screenshot of an image which was displayed on the display screen; and
(b) controlling, in a case where the first screenshot is a screenshot of a web page which was displayed on the display screen, the display screen to display at least one of a title of the web page and a URL of the web page so that the at least one of the title and the URL overlaps with the first screenshot.

6. (canceled)

7: A non-transitory computer-readable recording medium where a control program for causing a computer to function as the display control device as set forth in claim 1 is stored.
